(19) United States
(12) Patent Application Publication
(10) Pub. No.: US 2005/0267665 A1
(43) Pub. Date: Dec. 1, 2005

(54) Deceleration control system and deceleration control method for vehicle

(75) Inventors: Kunihiro Iwatsuki, Toyota-shi (JP); Kazuyuki Shiiba, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/094,216

(22) Filed: Mar. 31, 2005

(30) Foreign Application Priority Data
May 12, 2004 (JP) 2004-142730

(51) Int. Cl. G06G 7/00

(52) U.S. Cl. 701/70

(57) ABSTRACT

There is provided a deceleration control system for a vehicle, in which a braking force is applied to a vehicle by a braking device when a determination that a shift speed or a gear ratio of a transmission of a vehicle is changed to a shift speed or a gear ratio for a relatively low vehicle speed is made. Control is performed such that a deceleration (Gt), which is applied to the vehicle by activating the braking device and performing a shift operation for changing the shift speed or the gear ratio of the transmission of the vehicle to the shift speed or the gear ratio for the relatively low vehicle speed, becomes larger than a deceleration (402max), which is applied to the vehicle by only performing the shift operation.

The disclosure of Japanese Patent Application No. 2004-142730 filed on May 12, 2004 including the specification, drawings and abstract is incorporated herein by reference in its entirety.

### BACKGROUND OF THE INVENTION

1. Field of the Invention

The invention relates to a deceleration control system for a vehicle. More particularly, the invention relates to a deceleration control system for a vehicle which performs deceleration control for a vehicle by activating a braking device that generates a braking force applied to a vehicle and by performing an operation for changing a shift speed or a gear ratio of an automatic transmission to a shift speed or a gear ratio for a relatively low vehicle speed.

2. Description of the Related Art

As a technology for performing cooperative control of an automatic transmission and a brake, there is a known technology in which the brake is applied when shifting of the automatic transmission is manually performed such that an engine brake is applied. As such a cooperative control system for an automatic transmission and a brake is disclosed in Japanese Patent Application No. JP-2503426.

Japanese Patent Application No. JP-2503426 discloses a technology, in which a brake of a vehicle is applied so as to prevent idle running due to the neutral state from when shifting is started until when the engine brake is actually applied, in a case where shifting of the automatic transmission (A/T) is manually performed such that the engine brake is applied.

Also, Japanese Patent Application No. JP-2503426 has the following description. Until a predetermined period has elapsed since a command to manually perform downshifting is issued or during a period from when the command to manually perform downshifting is issued until when the engine brake starts to be actually applied (until when negative torque of an output shaft of the A/T becomes high), the brake of the vehicle is applied so as to correspond to a peak value of the negative engine torque during shifting, which is obtained based on a type of shifting, a vehicle speed, and the like. When shifting is manually performed, the brake of the vehicle is applied so as to generate a braking force corresponding to negative torque of the output shaft of the A/T for the shifting time. Therefore, a braking force is applied to the vehicle so as to correspond to a degree of an engine braking force when shifting is manually performed. During a period from when shifting is manually performed until when the shifting is completed, a stable braking force is applied to the vehicle, and a stable braking force having high a high response can be obtained when shifting is manually performed. When the automatic transmission is in the neutral state, since the brake of the vehicle is applied, and the engine brake is prevented from being applied abruptly. Therefore, fluctuation of the braking force decreases.

The engine braking force, which is obtained after the shift speed of the automatic transmission is changed to a shift speed for a relatively low vehicle speed, depends on the shift speed achieved by the shifting. If a driver feels that a sufficient engine braking force has not been obtained, shifting is performed repeatedly. Especially, if the number of shift speeds of the automatic transmission is increased and an range of the gear ratios, which is shared by multiple shift speeds, is increased, an amount of change in the engine braking force per one shift speed is small. Therefore, the driver may not feel that sufficient deceleration is obtained.

### SUMMARY OF THE INVENTION

It is an object of the invention to provide a deceleration control system for a vehicle, which can make a driver feel that sufficient deceleration is obtained when shifting is performed.

According to a first aspect of the invention, there is provided a deceleration control system for a vehicle including a braking device which applies a braking force to a vehicle when a determination that a shift speed or a gear ratio of a transmission of a vehicle is changed to a shift speed or a gear ratio for a relatively low vehicle speed is made; and a control device which controls a deceleration that is applied to the vehicle by the braking device, the deceleration being applied to a deceleration that is applied to the vehicle by performing a shift operation for changing the shift speed or the gear ratio of the transmission to the shift speed or the gear ratio for the relatively low vehicle speed.

In the first aspect, the deceleration added by the braking device may be decided based on at least one of the shift speed or the gear ratio obtained after shifting performed by the shift operation, a type of shifting performed by the shift operation, whether jump shifting has been performed by the shift operation, and a speed of the vehicle.

In the first aspect, the control device may control such that the deceleration that is applied to the vehicle by activating the braking device and performing the shift operation for changing the shift speed or the gear ratio of the transmission to the shift speed or the gear ratio for the relatively low vehicle speed becomes larger than a deceleration that is applied to the vehicle by only performing the shift operation for changing the shift speed or the gear ratio of the transmission to the shift speed or the gear ratio for the relatively low vehicle speed.

In an aspect related to the first aspect, the deceleration that is applied to the vehicle by activating the braking device and performing the shift operation may be decided based on at least one of the shift speed or the gear ratio obtained after shifting performed by the shift operation, a type of shifting performed by the shift operation, whether jump shifting has been performed by the shift operation, and a speed of the vehicle.

In the first aspect, application of the braking force, which is generated by the braking device, to the vehicle may be controlled to be maintained even after the shift operation ends.

In an aspect related to the first aspect, application of the braking force, which is generated by the braking device, to the vehicle may be controlled to be maintained for a predetermined period after the shift operation ends, and the predetermined period may be decided based on a running environment of the vehicle.

In the first aspect, the deceleration applied to the vehicle may be decided based on a running environment of the vehicle.

With the deceleration control system for a vehicle according to the above-mentioned aspects, it is possible to make the driver feel that sufficient deceleration is obtained when shifting is performed.

According to a second aspect of the invention, there is provided a deceleration control method for a vehicle including the steps of applying a braking force to a vehicle when a determination that a shift speed or a gear ratio of a transmission of a vehicle is changed to a shift speed or a gear ratio for a relatively low vehicle speed is made; and controlling a deceleration that is applied to the vehicle by a braking device, the deceleration being added to a deceleration that is applied to the vehicle by performing a shift operation for changing the shift speed or the gear ratio of the transmission to the shift speed or the gear ratio for the relatively low vehicle speed.

In the second aspect, the deceleration added by the braking device may be decided based on at least one of the shift speed or the gear ratio obtained after shifting performed by the shift operation, a type of shifting performed by the shift operation, whether jump shifting has been performed by the shift operation, and a speed of the vehicle.

In the second aspect, the deceleration that is applied to the vehicle by activating the braking device and performing a shift operation for changing the shift speed or the gear ratio of the transmission to the shift speed or the gear ratio for the relatively low vehicle speed may be controlled such that the deceleration becomes larger than a deceleration that is applied to the vehicle by only performing the shift operation for changing the shift speed or the gear ratio of the transmission to the shift speed or the gear ratio for the relatively low vehicle speed.

In an aspect related to the second aspect, the deceleration that is applied to the vehicle by activating the braking device and performing the shift operation may be decided based on at least one of the shift speed or the gear ratio obtained after shifting performed by the shift operation, a type of shifting performed by the shift operation, whether jump shifting has been performed by the shift operation, and a speed of the vehicle.

In the second aspect, application of the braking force, which is generated by the braking device, to the vehicle may be controlled to be maintained even after the shift operation ends.

In the second aspect, application of the braking force, which is generated by the braking device, to the vehicle may be controlled to be maintained for a predetermined period after the shift operation ends, and the predetermined period may be decided based on a running environment of the vehicle.

In the second aspect, the deceleration applied to the vehicle may be decided based on a running environment of the vehicle.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIGS. 1A and 1B are a flowchart showing a routine of control performed by a deceleration control system for a vehicle according to a first embodiment of the invention;

FIG. 2 is a view schematically showing the deceleration control system for a vehicle according to the first embodiment of the invention;

FIG. 3 is a view showing an automatic transmission in the deceleration control system for a vehicle according to the first embodiment of the invention;

FIG. 4 is a table showing an operation chart of the automatic transmission in the deceleration control system for a vehicle according to the first embodiment of the invention;

FIG. 5 is a time chart showing deceleration transient characteristics of the deceleration control system for a vehicle according to the first embodiment of the invention;

FIG. 6 is a table showing a maximum target deceleration map for the deceleration control system for a vehicle according to the first embodiment of the invention;

FIG. 7 is a table showing an additional amount map for the deceleration control system for a vehicle according to the first embodiment of the invention;

FIG. 8 is a graph showing an additional amount of a braking force and deceleration at each shift speed in the deceleration control system for a vehicle according to the first embodiment of the invention;

FIG. 9 is a graph for describing an inclination of the target deceleration for the deceleration control system for a vehicle according to the first embodiment of the invention;

FIG. 10 shows graphs for describing a method of deciding the inclination of the target deceleration for the deceleration control system for a vehicle according to the first embodiment of the invention;

FIG. 11 is a graph showing a change in the target deceleration in the case where jump shifting is performed in the deceleration control system for a vehicle according to the first embodiment of the invention;

FIG. 12 is a table showing an example of an additional increase amount for the deceleration control system for a vehicle according to the first embodiment of the invention;

FIG. 13 is a table showing another example of the additional increase amount for the deceleration control system for a vehicle according to the first embodiment of the invention;

FIG. 14A is a flowchart showing a part of a routine of control performed by a deceleration control system for a vehicle according to a second embodiment of the invention;

FIG. 14B is a flowchart showing another part of the routine of the control performed by the deceleration control system for a vehicle according to the second embodiment of the invention;

FIG. 15 is a flowchart for describing a part of a step for deciding maximum target deceleration for the deceleration control system for a vehicle according to the second embodiment of the invention;

FIG. 16 shows maps used in a part of the step for deciding the maximum target deceleration for the deceleration control system for a vehicle according to the second embodiment of the invention;

FIG. 17 is a flowchart for describing a part of a step for deciding a predetermined period for the deceleration control system for a vehicle according to the second embodiment of the invention;

FIG. 18 shows maps used in a part of the step for deciding the predetermined period for the deceleration control system for a vehicle according to the second embodiment of the invention;

FIG. 19 is a flowchart for describing a part of a step for deciding a decrease inclination for the deceleration control system for a vehicle according to the second embodiment of the invention; and

FIG. 20 shows maps used in a part of the step for deciding the decrease inclination for the deceleration control system for a vehicle according to the second embodiment of the invention.

### DETAILED DESCRIPTION OF THE PREFERRED EMBODIMENTS

Hereafter, a deceleration control system for a vehicle according to an embodiment of the invention will be described in detail with reference to accompanying drawings.

### First Embodiment

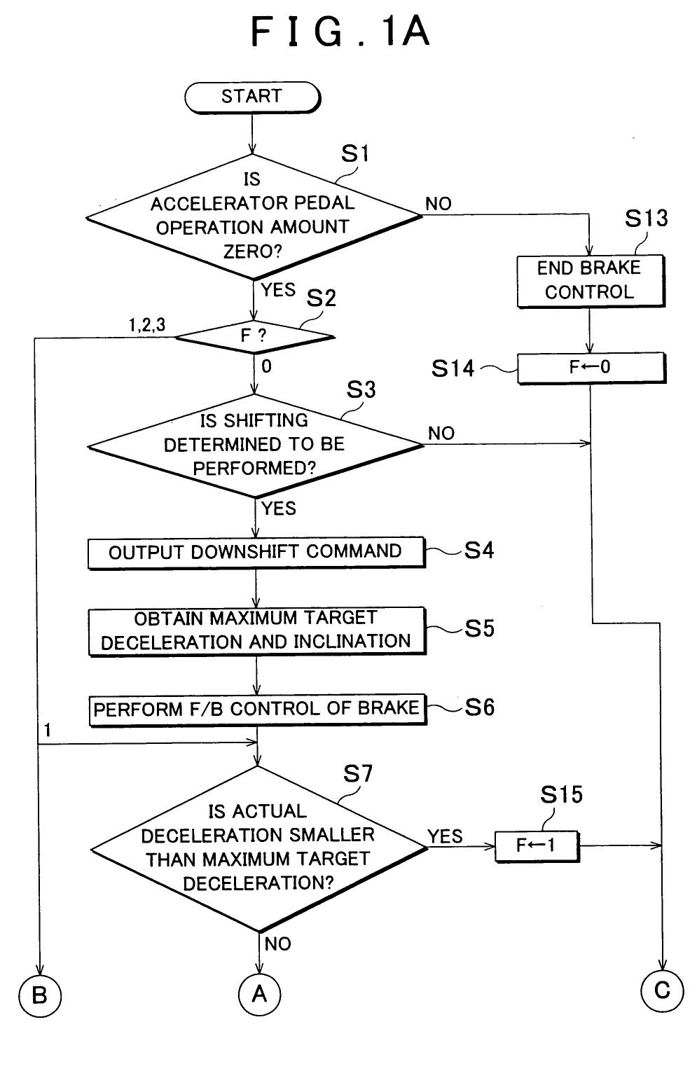

A deceleration control system for a vehicle according to a first embodiment will be described with reference to FIGS. 1A to 13. The first embodiment relates to a deceleration control system for a vehicle which performs cooperative control of a braking device and an automatic transmission. It is an object of the first embodiment to provide a deceleration control system which can make a driver feel that sufficient deceleration is obtained when shifting to a shift speed for a relatively low vehicle speed is performed. It is another object of the first embodiment to provide a deceleration control system for a vehicle which can make it possible to improve deceleration transient characteristics of a vehicle.

When deceleration (braking force) is applied to the vehicle, the state of the vehicle may become unstable. However, Japanese Patent Application Publication JP(A) 2503426 does not disclose a technology for dealing with this problem. Therefore, it is another object of the invention to provide a deceleration control system for a vehicle which can easily deal with an unstable state of a vehicle, when the state becomes unstable.

The deceleration control system according to the embodiment is a cooperative control system of a braking device (including a brake and a motor generator) and an automatic transmission (a stepped transmission or a continuously variable transmission) when downshifting is manually performed (hereinafter, referred to as “manual downshifting” where appropriate) or downshifting is performed by shift point control. In the embodiment, a target deceleration is set to a value equal to or higher than a deceleration that can be obtained by performing downshifting of the automatic transmission. In the embodiment, the target deceleration is set such that there range target deceleration for an initial stage (first period) in which the deceleration is inclined even if the inclination is small and a target deceleration for a second period in which the deceleration is substantially zero, the second period being after the first period.

Manual downshifting means downshifting manually performed by the driver when the driver desires an increase in an engine braking force. Also, shift point control means deceleration control performed by changing the shift speed to a shift speed for a relatively low vehicle speed based on information concerning a road on which the vehicle is running, for example, a corner R, a road inclination ahead of the vehicle, and an intersection; information concerning traffic of the road on which the vehicle is running, for example, a vehicle-to-vehicle distance; and the like. Namely, the shift point control includes downhill control based on a road inclination, corner control based on the corner R, intersection control based on information concerning an intersection, and adaptive cruise control based on a vehicle-to-vehicle distance.

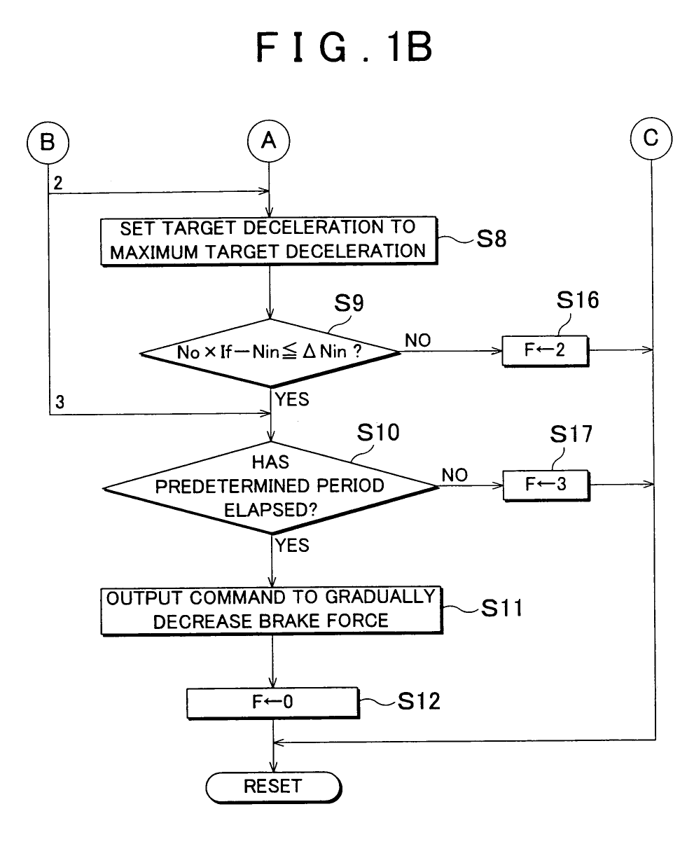

In FIG. 2, a reference numeral “10” signifies an automatic transmission, a reference numeral “40” signifies an engine, and a reference numeral “200” signifies a brake device. In the automatic transmission 10, hydraulic pressure is controlled by energizing/de-energizing electromagnetic valves 121a, 121b, and 121c, whereby shifting can be performed among five shift speeds. In FIG. 2, the three electromagnetic valves 121a, 121b, and 121c are shown. However, the number of electromagnetic valves is not limited to three. The electromagnetic valves 121a, 121b and 121c are controlled according to a signal transmitted from a control circuit 130.

A throttle valve opening amount sensor 114 detects an opening amount of a throttle valve 43 provided in an intake passage 41 of the engine 40. An engine rotational speed sensor 116 detects a rotational speed of the engine 40. A vehicle speed sensor 122 detects a rotational speed of an output shaft 120c of the automatic transmission 10, which is proportional to the vehicle speed. A shift position sensor 123 detects a shift position. A pattern select switch 117 is used when a command a shift pattern is selected.

An acceleration sensor 90 detects a deceleration of the vehicle. A manual shift determining portion 95 outputs a signal indicating that downshifting (manual downshifting) or upshifting manually performed by the driver is required based on the manual operation of the driver. A road surface friction factor μ detecting/estimating portion 115 detects or estimates a friction factor μ of a road surface. A vehicle-to-vehicle distance detecting/estimating portion 100 includes a sensor such as a laser radar sensor or a millimeter-wave radar sensor mounted in a front portion of the vehicle, and measures a distance between the host vehicle and a preceding vehicle. A relative vehicle speed detecting/estimating portion 112 detects or estimates a relative speed between the host vehicle and the preceding vehicle.

A road inclination measuring/estimating portion 118 may be provided as a part of a CPU 131. The road inclination measuring/estimating portion 118 may measure or estimate a road inclination based on the acceleration detected by he acceleration sensor 90. Also, the road inclination measuring/estimating portion 118 may obtain a road inclination by comparing a acceleration at a flat road, which is stored in ROM 133 in advance, with the acceleration which is actually detected by the acceleration sensor 90.

A navigation system device 113 has a basic function for guiding the host vehicle to a predetermined destination. The navigation system device 113 includes an arithmetic processing unit; an information storing medium which stores information necessary for running of the vehicle (maps, straight roads, curves, uphill/downhill roads, highways, and the like); a first information detecting device which detects a present position of the host vehicle and a road state by self-contained navigation, and which includes a terrestrial magnetism sensor, a gyro compass, and a steering sensor; and a second information detecting device which detects a present position of the host vehicle and a road state by radio navigation, and which includes a GPS antenna, a GPS receiver, and the like.

The control circuit 130 receives signals indicating detection results transmitted from the throttle valve opening amount sensor 114, the engine rotational speed sensor 116, the vehicle speed sensor 122, the shift position sensor 123, and the acceleration sensor 90, signals indicating a switching state of the pattern select switch 117, a signal indicating a result of detection/estimation performed by the road surface friction factor μ detecting/estimation portion 115, a signal indicating necessity of shifting, which is transmitted from the manual shift determining portion 95, a signal transmitted from the navigation system device 113, a signal indicating a result of detection/estimated performed by the relative vehicle speed detecting/estimating portion 112, and a signal indicating a result of measurement performed by the vehicle-to-vehicle distance measuring portion 100. The control circuit 130 determines whether shifting is determined to be performed by the shift point control including the downhill control, the corner control, the intersection control and the adaptive cruise control.

The control circuit 130 is formed of a known microcomputer, and includes the CPU 131, RAM 132, the ROM 133, an input port 134, an output port 135, and a common bus 136. The input port 134 receives signals from the above-mentioned various sensors 114, 116, 122, 123, and 90, a signal from the pattern select switch 117, and signals from the road surface friction factor μ detecting/estimating portion 115, the manual shift determining portion 95, the vehicle-to-vehicle distance measuring portion 100, the relative vehicle speed detecting/estimating portion 112, and the navigation system device 1113. The output port 135 is connected to electromagnetic valve drive portions 138a, 138b, and 138c and a braking force signal line L1 extending to a brake control circuit 230. A braking force signal SG1 is transmitted through the braking force signal line L1.

In the ROM 133, an operation (control routine) shown in a flowchart in FIGS. 1A and 1B are stored in advance, and a shift map for changing the shift speed of the automatic transmission 10 and an operation of shift control (not shown) are stored. The control circuit 130 performs shifting of the automatic transmission 10 based on the various control conditions input therein.

The brake device 200 is controlled by the brake control circuit 230 which receives the braking force signal SG1 from the control circuit 130, thereby applying a braking force to the vehicle. The brake device 200 includes a hydraulic control circuit 220, and braking devices 208, 209, 210 and 211 which are provided for wheels 204, 205, 206 and 207, respectively. The braking devices 208, 209, 210 and 211 control the braking forces applied to the corresponding wheels 204, 205, 206 and 207, when the braking hydraulic pressure is controlled by the hydraulic control circuit 220. The hydraulic control circuit 220 is controlled by the brake control circuit 230.

The hydraulic control circuit 220 performs brake control by controlling the braking hydraulic pressure supplied to the braking devices 208, 209, 210 and 211 according to a brake control signal SG2. The brake control signal SG2 is generated by the brake control circuit 230 based on the braking force signal SG1. The braking force signal SG1 is output from the control circuit 130 of the automatic transmission 10, and input in the brake control circuit 230. The braking force applied to the vehicle during the brake control is decided according to the brake control signal SG2 which is generated by the brake control circuit 230 based on various data contained in the braking force signal SG1.

The brake control circuit 230 is formed of a known microcomputer, and includes a CPU 231, RAM 232, ROM 233, an input port 234, an output port 235, and a common bus 236. The hydraulic control circuit 220 is connected to the output port 235. The ROM 233 stores an operation which is performed when the brake control signal SG2 is generated based on the various data contained in the braking force signal SG1. The brake control circuit 230 performs control of the brake device 200 (brake control) based on the various control conditions input therein.

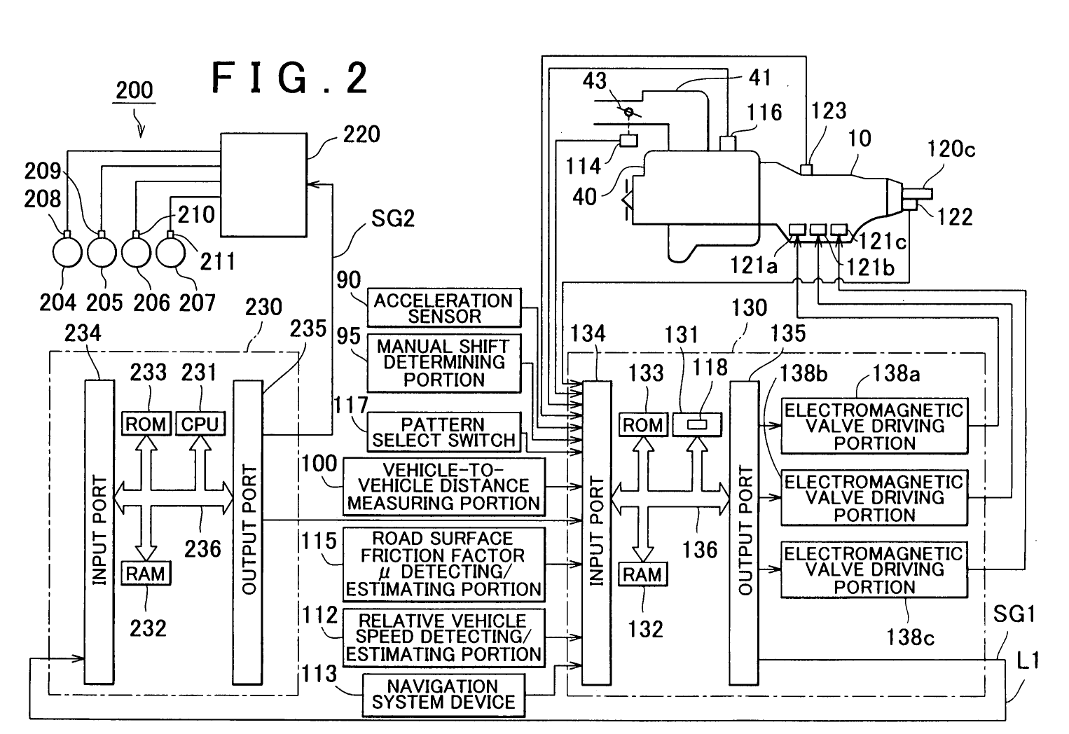

Next, a structure of the automatic transmission 10 will be described with reference to FIG. 3. In FIG. 3, an output from the engine 40, which is formed of an internal combustion engine and which serves as a power supply for running, is input in the automatic transmission 10 via an input clutch 12 and a torque converter 14 serving as a hydraulic power transmission device, and transmitted to drive wheels via a differential gear unit and a axle (not shown). A first motor generator MG1, which serves as an electric motor and an electric power generator, is provided between the input clutch 12 and the torque converter 14.

The torque converter 14 includes a pump impeller 20 which is coupled with the input clutch 12; a turbine runner 24 which is coupled with an input shaft 22 of the automatic transmission 10; a lock-up clutch 26 for directly connecting the pump impeller 20 to the turbine runner 24; and stator 30 whose rotation in one direction is prevented by a one way clutch 28.

The automatic transmission 10 includes the input shaft 22 and the output shaft 120c. In the automatic transmission 10, a double pinion planetary gear 32 including a sun gear S1, a carrier CR1, and a ring gear R1; a single planetary gear 34 including a sun gear S2, a carrier CR2 and a ring gear R2; and a single planetary gear 36 including a sun gear S3, a carrier CR3 and a ring gear R2 are provided coaxially with the input shaft 22 and the output shaft 120c. On the input side of the automatic transmission 10, a so-called double clutch formed of two clutches is provided on each of the inner peripheral side and the outer peripheral side. Namely, a clutch C-1 and a clutch C-4 are provided on the inner peripheral side, and a clutch C-2 and a clutch C-3 are provided on the outer peripheral side.

The clutch C-4 is connected to the sun gear S2 and the sun gear S3. The clutch C-1 is connected to the sun gear S2 and the sun gear S3 via a one-way clutch F-0. The clutch C-3 is connected to the sun gear S1, and rotation of the sun gear S1 in one direction is prevented by a one-way clutch F-1 which is engaged when a brake B-3 is applied. Rotation of the carrier CR1 in one direction is prevented by the one-way clutch F1, and can be fixed by a brake B-1. Also, the ring gear R1 is connected to the ring gear R2, and the ring gear R1 and the ring gear R2 can be fixed by a brake B-2. The clutch C-2 is connected to the carrier CR2, and carrier CR2 is connected to the ring gear R3. Rotation of each of the carrier CR2 and the ring gear R3 in one direction is prevented by a one-way clutch F-3. The carrier CR2 and the ring gear R3 can be fixed by a brake B-4. The carrier CR3 is connected to the output shaft 120c.

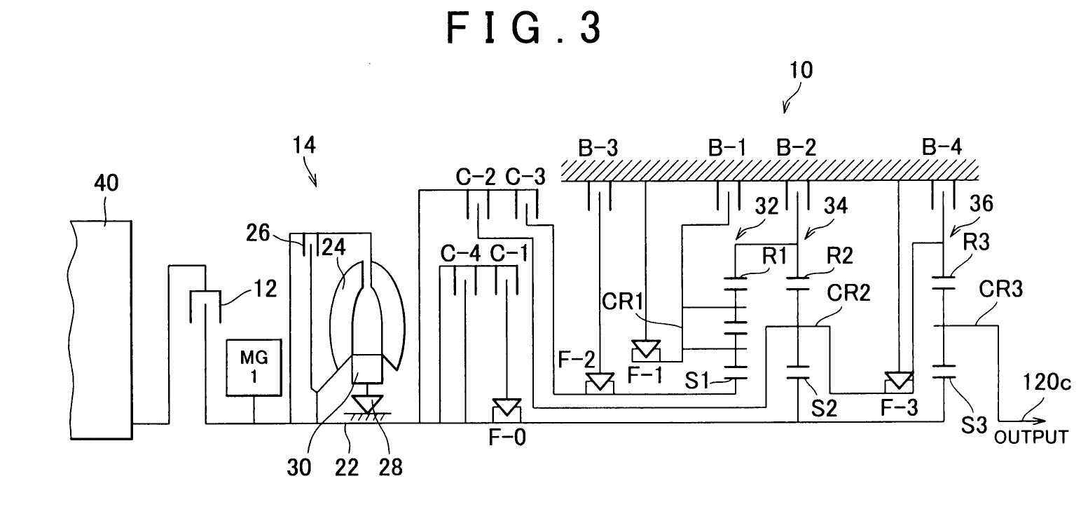

In the thus configured automatic transmission 10, the shift speed is changed among one reverse speed and six forward speeds (1st to 6th) whose gear ratios are different from each other according to, for example, an operation chart shown in FIG. 4. In FIG. 4, a circle indicates an engaged/applied state, a blank column indicates a disengaged/released state, a circle in parentheses shows an engaged/applied state which is realized when the engine brake is applied, and a black circles indicates an engaged/applied state which is not related to power transmission. Each of the clutches C1 to C4 and brakes B1 to B4 is a hydraulic friction engaging device which is engaged/applied by a hydraulic actuator.

Next, an operation of the deceleration control system according to the first embodiment will be described with reference to FIGS. 1A to 5.

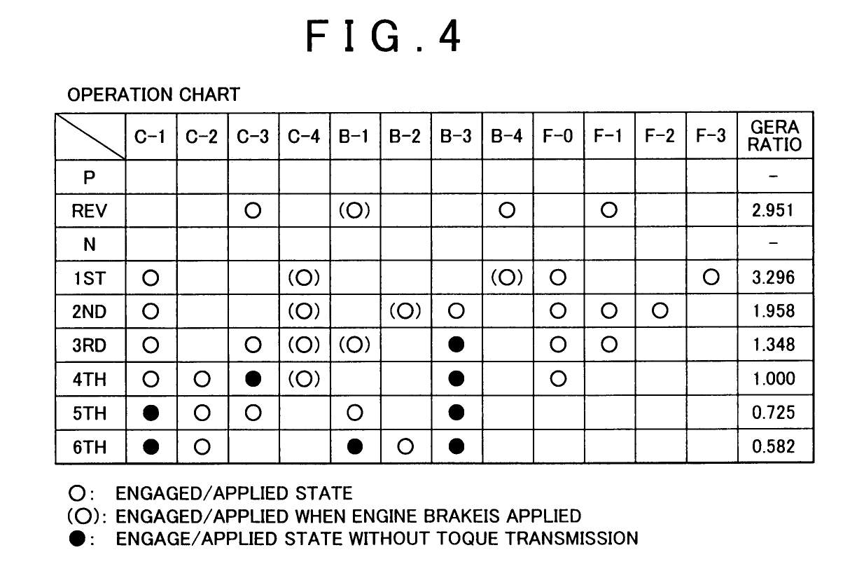

FIGS. 1A and 1B are a flowchart showing a routine of control according to the first embodiment. FIG. 5 is a time chart for describing the embodiment. FIG. 5 shows an input rotational speed of the automatic transmission 10, an accelerator pedal operation amount, a brake control amount, clutch torque, output shaft torque or a deceleration (G) applied to the vehicle.

[Step S1]

As shown in FIGS. 1A and 1B, in step S1, the control circuit 130 determines whether an accelerator pedal operation amount is zero based on the detection result obtained by the throttle valve opening amount sensor 114. When it is determined that the accelerator pedal operation amount is zero (“YES” in step S1), if shifting is performed, it is determined that the engine brake is required to be applied in the shifting, and the brake control according to the embodiment, which is defined in step S2 and the following steps, is performed. In FIG. 5, as shown by a reference numeral “401”, the accelerator pedal operation amount becomes “0” at time t1.

On the other hand, when it is determined in step S1 that the accelerator pedal operation amount is not “0” (“NO” in step S1), a command to end the brake control according to the embodiment is issued in step S13. If the brake control is not performed at this time, the state is maintained as it is. Next, a flag F is reset to “0” in step S14, afterwhich the control routine is reset. When the accelerator pedal operation amount is not “0” (“NO” in step S1), an intention of driver for deceleration is relatively weak. Therefore, the deceleration control according to the invention, which is performed in order to make the driver feel that sufficient deceleration is obtained, is not performed.

[Step S2]

In step S2, the control circuit 130 checks the flag F. The flag F is “0” at the beginning of the control routine. Therefore, step S3 is performed. When the flag F is “1”, step S7 is then performed. When the flag F is “2”, step S8 is then performed. When the flag F is “3”, step S10 is then performed.

[Step S3]

In step S3, the control circuit 130 determines whether shifting is determined to be performed (whether a shift command has been issued). In this case, it is determined whether a signal indicating that the shift speed of the automatic transmission 10 needs to be changed to a relatively low shift speed (downshifting needs to be performed) has been output from the manual shift determining portion 95. It is also determined whether a signal has been output which indicates that downshifting needs to be performed as the shift point control based on the information transmitted from the vehicle-to-vehicle distance measuring portion 100, the relative vehicle speed detecting/estimating portion 112, the navigation system device 113, the road inclination measuring/estimating portion 118 and the like. In this case, the shift point control includes the downhill control, the corner control, the intersection control, and the adaptive cruise control.

In FIG. 5, the determination in step S3 is made at time t1. When it is determined in step S3 that the signal indicating that downshifting needs to be performed is output from the manual shift determining portion 95, or the signal indicating that downshifting needs to be performed as the shift point control is output (“YES” in step S3), step S4 is then performed. On the other hand, when a negative determination is made in step S3 (“NO” in step S3), the control routine is reset.

An example, in which the operation for making the acceleration pedal operation amount “0” is performed at time t1, has been described. However, the operation may be performed any time before time t1 at which step S3 is performed. In the example shown in FIG. 5, the case, in which the control circuit 130 determines at time t1 that downshifting needs to be performed, is shown concerning a signal indicating that downshifting needs to be performed. As will be described later in detail, in step S4, the control circuit 130 outputs a downshift command at time t1 at which the determination that downshifting needs to be performed is made.

[Step S4]

In step S4, a downshift command (shift command) is output from the CPU 131 of the control circuit 130 to the electromagnetic valve drive portions 138a to 138c. In response to the downshift command, the electromagnetic drive portions 138a to 138c energize/de-energize the electromagnetic valves 121a to 121c. Thus, shifting according to the downshift command is performed in the automatic transmission 10. When the control circuit 130 determines at time t1 that downshifting needs to be performed (“YES” in step S3), the downshift command is output simultaneously with the determination made at time t1.

As shown in FIG. 5, when the downshift command is output at time t1, clutch torque 407 of a disengagement side element of the automatic transmission 10 decreases, and slipping starts near time t2. From time t2, transmission of torque from the wheel side to the automatic transmission 10 side becomes difficult, and a force for increasing the input rotational speed decreases. Therefore, an input rotational speed 400 decreases. At time t3, that is, the time at which a predetermined period ta, which is decided based on a type of shifting (a combination of a shift speed before shifting and a shift speed after shifting, for example, 4→3 (shifting from fourth speed to third speed), and 3→2 (shifting from third speed to second speed)), has elapsed since time t1 at which the downshift command is output, engagement clutch torque 408 starts to increase, and a deceleration 402 due to shifting of the automatic transmission 10 and the input rotational speed 400 start to increase. After step S4 is performed, step S5 is performed.

[Step S5]

In step S5, a maximum target deceleration Gt and an inclination α1 are obtained by the control circuit 130. First, the maximum target deceleration Gt will be described, and then, the inclination α1 will be described.

A. Concerning Maximum Target Deceleration Gt

In FIG. 5, a dashed line 402 indicated by a reference numeral “402” shows the deceleration (deceleration due to shifting) corresponding to the negative torque (a braking force, the engine brake) of the output shaft 120c of the automatic transmission 10. The deceleration 402, which is applied to the vehicle due to shifting of the automatic transmission 10, is decided based on the type of shifting and the vehicle speed.

A reference numeral “402max” signifies the maximum value of the deceleration 402 which is applied to the vehicle due to shifting of the automatic transmission 10. The maximum deceleration 402max due to shifting is decided based on the shift speed and the vehicle speed achieved after shifting.

In this case, the maximum target deceleration Gt is decided so as to be higher than the maximum deceleration 402max due to shifting, as required, based on the type of shifting (the shift speed achieved after shifting), the vehicle speed, and whether jump shifting has been performed. The effect of setting the maximum target deceleration Gt to a value higher than the maximum deceleration 402max due to shifting will be described below.

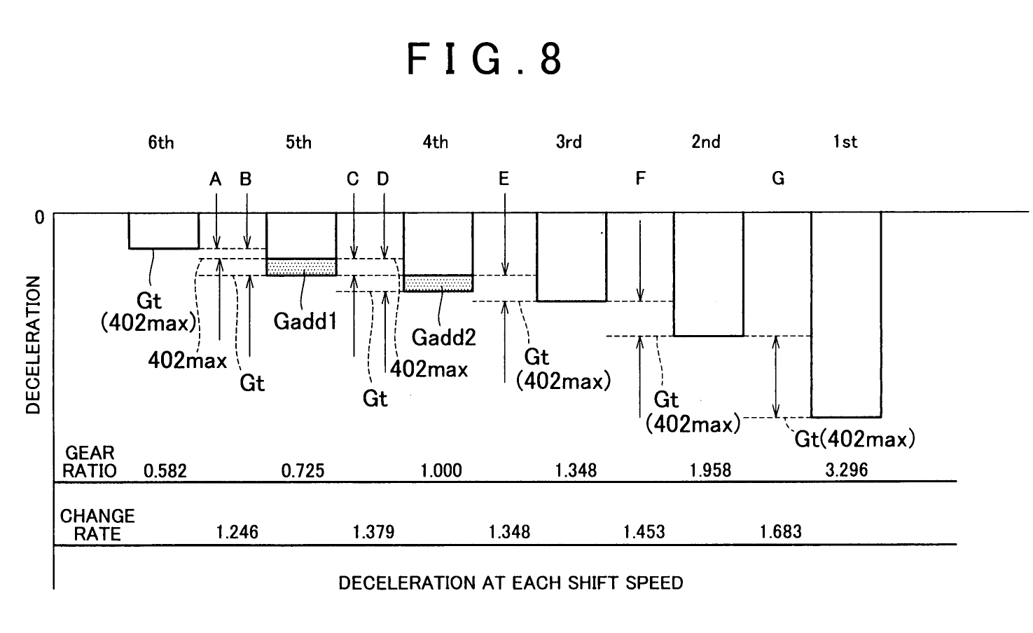

First, the reason why the driver may not feel that sufficient deceleration is obtain will be described with reference to FIG. 8. FIG. 8 shows the deceleration (maximum deceleration 402max) at each shift speed of the automatic transmission 10. Generally, the gear ratios are set in geometric progression. As shown in the example of the gear ratios of the automatic transmission 10 shown in FIG. 8 (refer to FIG. 4), the change rate of the gear ratio tends to be higher as the shift speed becomes lower. In FIG. 8, the deceleration at each shift speed is shown as a value of deceleration which depends on only the gear ratio when the deceleration at sixth speed is used as a reference value.

The change in the engine braking force (the change in maximum deceleration 402max) due to shifting on the high shift speeds side (for example shifting from sixth speed to fifth speed) is considerably smaller than the change in the engine braking force due to shifting on the low shift speed side (for example, shifting from second speed to first speed) (refer to reference characters “A” and “B” in FIG. 8). As the number of shift speeds is increased, this tendency becomes more noticeable. When the number of shift speeds is increased, generally, the total range of the gear ratios is increased, and also the range of the gear ratios, which is shared by adjacent shift speeds, is increased. In addition, actually, the engine rotational speed increases as the shift speed becomes lower. Therefore, the difference between the amount of change in the engine braking force due to shifting on the low shift speed side and the amount of change in the engine braking force on the high shift speed side further increases. As a result, the driver cannot feel that sufficient deceleration is obtained when downshifting is performed (if the number of shift speeds is increased, the driver cannot feel that sufficient deceleration is obtained especially on the high shift speed side).

Recently, the number of shift speeds of the automatic transmission has been increased, and therefore the number of shift positions for the shift lever is excessively increased, which causes problems that (1) the shift lever requires a large space, and (2) the shift lever is difficult to use. Accordingly, a shift lever of a sequential type is employed in many cases. When the shift lever of a sequential type is employed, if the lever is operated toward the decrease side once, the shift speed is decreased by one speed. However, as mentioned above, since the number of shift speeds is increased, a change amount in the engine braking force obtained by changing the shift speed by one shift speed is small, which causes problems that the driver hardly obtains a response from the vehicle even if the driver operates the lever, and that the driver needs to operate the lever many times in order to obtain desired deceleration.

In this case, if the shift speed is changed to a medium shift speed and the desired shift speed is selected by an operation between the increase side and the decrease side, a certain amount of engine braking force can be obtained. However, even on a road on which the vehicle can run at high shift speed, the vehicle needs to run at a medium shift speed. As a result, the fuel efficiency deteriorates.

Therefore, in the embodiment, a deceleration (braking force) is added when shifting is performed, especially, on the high shift speed side. Thus, even when shifting is performed on the high shift speed side, the driver can feel that sufficient deceleration is obtained. In FIG. 8, when shifting from sixth speed to fifth speed is performed, a predetermined amount of braking force Gadd1 is added, whereby a change amount of the deceleration is increased from an amount A to an amount B, and the driver can feel that sufficient deceleration is obtained. Similarly, when shifting from fifth speed to fourth speed is performed, a predetermined amount of braking force Gadd2 is added, whereby a change amount of the deceleration is increased from an amount C to an amount D, and the driver can feel that sufficient deceleration is obtained.

The additional amount Gadd of the braking force is changed based on the type of shifting, the vehicle speed, or whether jump shifting has been performed (described later in detail). When additional braking force is applied at two or more shift speeds, the additional amount Gadd of the braking force is increased as shifting is performed on the higher shift speed side. Thus, it is possible to address the problem that the driver feels that sufficient deceleration cannot be obtained especially on the high shift speed side. FIG. 8 shows an example in which the additional amount Gadd of the braking force is applied only when downshifting to fifth speed or downshifting to fourth speed is performed, and the additional amount Gadd is not applied when downshifting to third speed or a lower speed is performed. However, the embodiment is not limited to this example. In the embodiment, the additional amount Gadd needs to be applied at least when shifting is performed on the high shift speed side. Further, the additional amount Gadd may be applied when shifting is performed on the low shift speed side.

The additional amount Gadd of the braking force when jump shifting is performed is made larger than the additional amount Gadd of the braking force when single shifting is performed (described later in detail). For example, when shifting to fourth speed is performed while shifting from sixth speed to fifth speed is being performed (namely, when jump shifting from sixth speed to fourth speed is performed), the additional amount Gadd1 of the braking force is applied due to shifting from sixth speed to fifth speed. As a result, a change amount of the deceleration due to shifting from fifth speed to fourth speed decreases. Namely, the difference between the deceleration at fifth speed which includes the additional amount Gadd1 of the braking force, and the deceleration at fourth speed which includes the additional amount Gadd2 of the braking force becomes small. Therefore, the additional amount of the braking force when jump shifting from sixth speed to fourth speed is performed is preferably made larger than the additional amount Gadd2 of the braking force which is applied when the single shifting from fifth speed to fourth speed is performed, thereby making the driver feel that sufficient deceleration corresponding to the jump shifting is obtained.

As described above, in the embodiment, the maximum target deceleration Gt is decided so as to be higher, by the predetermined amount Gadd, than the maximum value 402max of the deceleration 402 which is applied to the vehicle due to shifting of the automatic transmission 10. A method of obtaining the maximum target deceleration Gt will be described below.

(1) The maximum value 402max of the deceleration 402 due to shifting is obtained.

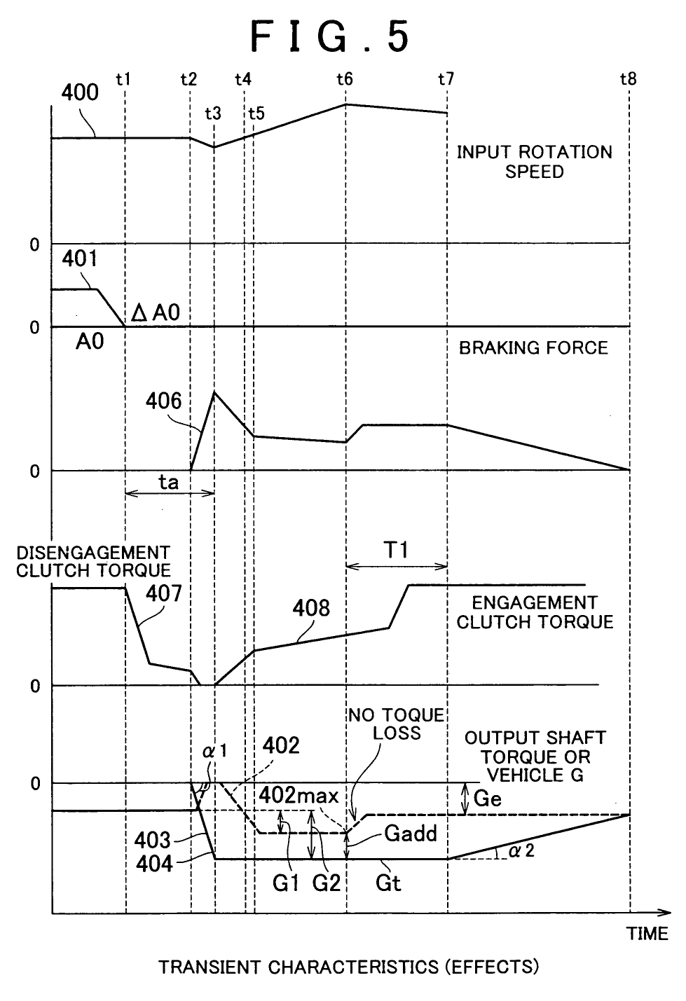

The maximum value 402max of the deceleration 402 due to shifting is decided with reference to a maximum deceleration map (FIG. 6) stored in the ROM 133 in advance. In the maximum deceleration map, the value of the maximum deceleration 402max is set as a value based on the type of shifting and the vehicle speed. As shown in FIG. 6, when a rotational speed No of the output shaft 120c of the automatic transmission 10 is 1000 [rpm], if downshifting to fifth speed is performed, the maximum value 402max of the deceleration 402 due to shifting is −0.04 G When the rotational speed No is 3000 [rpm], if downshifting to fourth speed is performed, the maximum value 402max of the deceleration 402 due to shifting is −0.07 G

(2) The additional amount Gadd of deceleration is obtained.

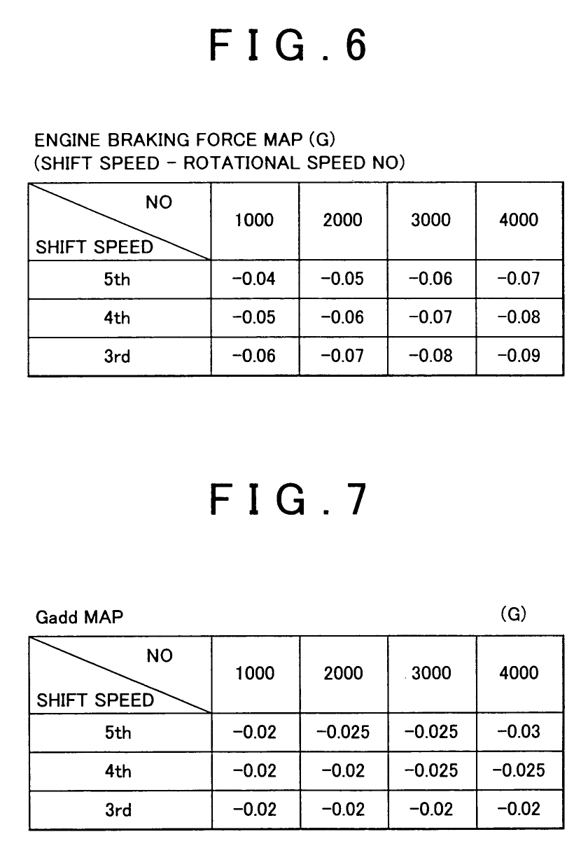

The additional amount Gadd of the braking force is decided with reference to an additional amount map (FIG. 7) stored in the ROM 133 in advance. In the additional amount map, the value of the additional amount Gadd of the braking force is set as a value based on the type of shifting and the vehicle speed. As shown in FIG. 7, when the rotational speed No is 1000[rpm], if downshifting to fifth speed is performed, the additional amount Gadd is −0.02 G When the rotational speed No is 3000[rpm], if downshifting to fourth speed is performed, the additional amount Gadd is −0.025 G. The additional amount Gadd is not a value theoretically calculated but a value obtained by an experiment. As shown in FIG. 7, as a whole, the additional amount Gadd becomes larger as shifting is performed on the higher shift speed side, and tends to be larger as the rotational speed No increases.

(3) The amount of increase in the additional amount (hereinafter, referred to as the “additional increase amount) Gadd′ when jump shifting is performed is obtained.

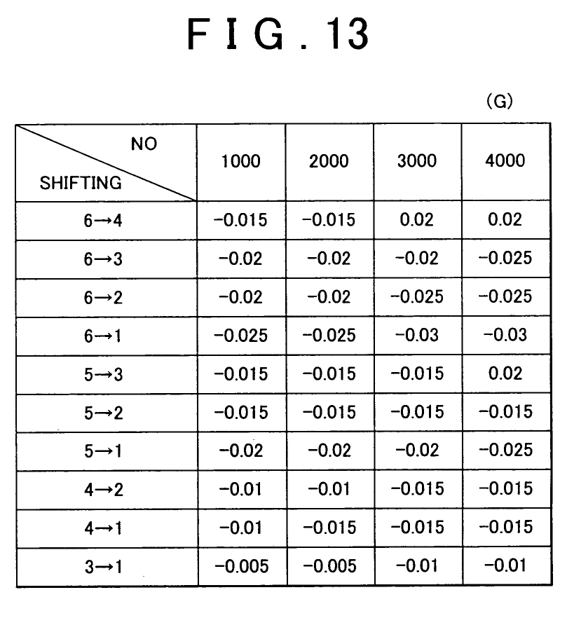

The additional amount of the braking force for the maximum deceleration 402max when jump shifting is performed is larger than the additional amount of the braking force when single shifting is performed. The additional increase amount Gadd′ is an amount of increase in the additional amount of the braking force for the maximum deceleration 402max. The additional increase amount Gadd′ is obtained by subtracting the additional amount when single shifting is performed from the additional amount when jump shifting is performed. The additional increase amount Gadd′ is decided with reference to an additional increase amount map (FIG. 12) stored in the ROM 133 in advance. In the additional increase amount map, the value of the additional increase amount Gadd′ of the braking force is set based on a skip amount of shifting and the vehicle speed.

In this case, the skip amount of shifting is the number of skipped shift speed when shifting is performed from one shift speed to another shift speed by skipping the shift speed therebetween (for example, shifting from sixth speed to fourth speed) without performing shifting from one shift speed to the adjacent shift speed (for example, shifting from sixth speed to fifth speed). For example, the skip amount is “1”, when shifting is performed from sixth speed to fourth speed, from fifth speed to third speed, or from fourth speed to second speed. The skip amount is “2”, when shifting is performed from sixth speed to third speed, from fifth speed to second speed, or from fourth speed to first speed. The skip amount is “3”, when shifting is performed from sixth speed to second speed, or from fifth speed to first speed. The skip amount is “4”, when shifting is performed from sixth speed to first speed.

As shown in FIG. 12, when the rotational speed No is 1000[rpm], if downshifting from sixth speed to fourth speed is performed, the additional increase amount Gadd′ is −0.01 G. When the rotational speed No is 3000 [rpm], if downshifting from fifth speed to second speed is performed, the additional increase amount Gadd′ is −0.021 G. The additional increase amount Gadd′ is not a theoretically calculated value, but a value obtained by an experiment. As shown in FIG. 12, as a whole, the additional increase amount Gadd′ increases as the skip amount of shifting increases, and tends to be larger as the rotational speed NO increases.

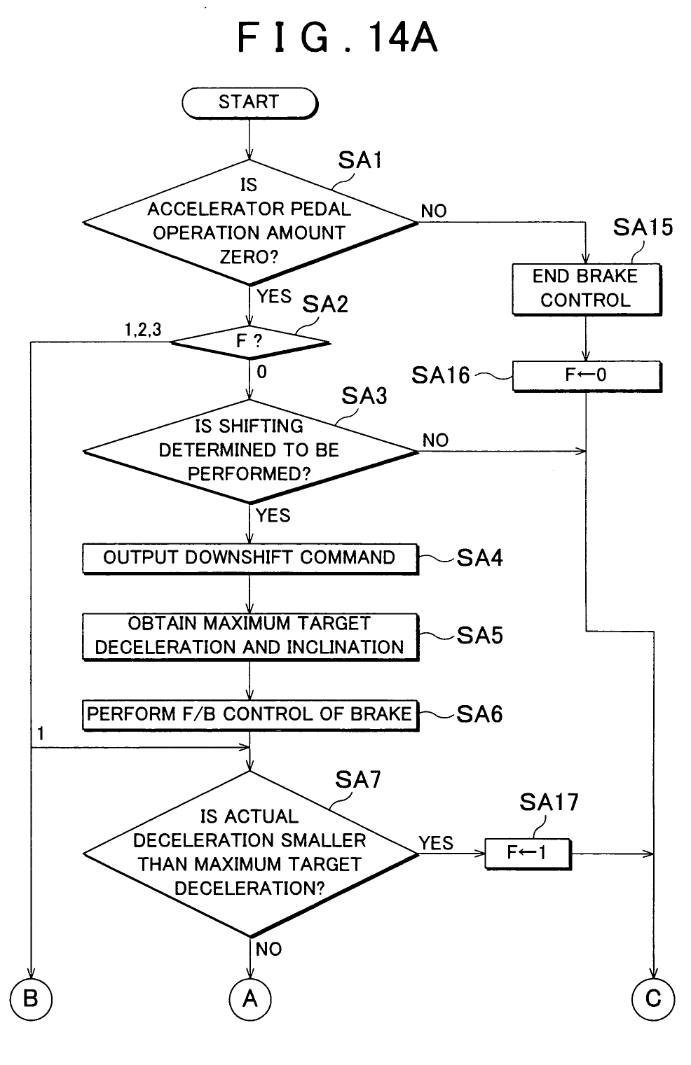

In the additional increase amount map in FIG. 12, when the rotational speed No is the same and the skip amount of shifting is also the same, the additional increase amount Gadd′ is obtained as the same value. For example, each of the skip amount of shifting from sixth speed to fourth speed and the skip amount of shifting from fifth speed to third speed is “1”. Therefore, in this case, if the rotational speed No is the same, the additional increase amount Gadd′ is the same. Instead of the additional increase amount map shown in FIG. 12, a map shown in FIG. 13 can be used. In the map shown in FIG. 13, the additional increase amount Gadd′ is obtained in consideration of not only the skip amount of shifting but also the shift speed before shifting is performed.

As shown in FIG. 13, each of the skip amount of shifting from sixth speed to fourth speed and the skip amount of shifting from fifth speed to third speed is “1”. However, the additional increase amount Gadd′ in shifting from sixth speed to fourth speed is 0.02 G, and the additional increase amount Gadd′ in shifting from fifth speed to third speed is 0.015 G, when the rotational speed N0 is 3000[rpm]. As a whole, the additional increase amount Gadd′ shown in FIG. 13 has the above-mentioned tendency (the additional increase amount Gadd′ increases as the skip amount of shifting increases, and increases as the rotational speed No increases). Further, the additional increase amount Gadd′ is set to increase as shifting is performed on the higher shit speed side.

After the above-mentioned operations (1) to (3) are performed, the maximum target deceleration Gt is obtained as below. For example, if shifting from sixth speed to fifth speed is performed when the rotational speed No is 1000[rpm], by performing the above-mentioned operation (1), the maximum deceleration 402max of −0.04 is obtained (refer to FIG. 6). By performing the above-mentioned operation (2), the additional amount Gadd of −0.02 G is obtained (refer to FIG. 7). By performing the above-mentioned operation (3), the additional increase amount Gadd′ of 0 is obtained (refer to FIG. 12 or FIG. 13). Therefore, the maximum target deceleration Gt becomes −0.06 G (the maximum target deceleration Gt=−0.04+(0.02)+0=−0.06 G).

Also, for example, if shifting from sixth speed to fourth speed is performed when the rotational speed No is 1000[rpm], by performing the above-mentioned operation (1), the maximum deceleration 402max of 0.05 G is obtained (refer to FIG. 6). By performing the above-mentioned operation (2), the additional amount Gadd of −0.02 G is obtained (refer to FIG. 7). By performing the above-mentioned operation (3), the additional increase amount Gadd′ of −0.01 G is obtained (in the case shown in FIG. 12) (in the case of FIG. 13, the additional increase amount Gadd′ of −0.015 G is obtained). Therefore, the maximum target deceleration Gt becomes −0.08 G (the maximum target deceleration Gt=−0.05+(−0.02)+0.01=−0.08 G) (when the additional increase amount map in FIG. 12 is used).

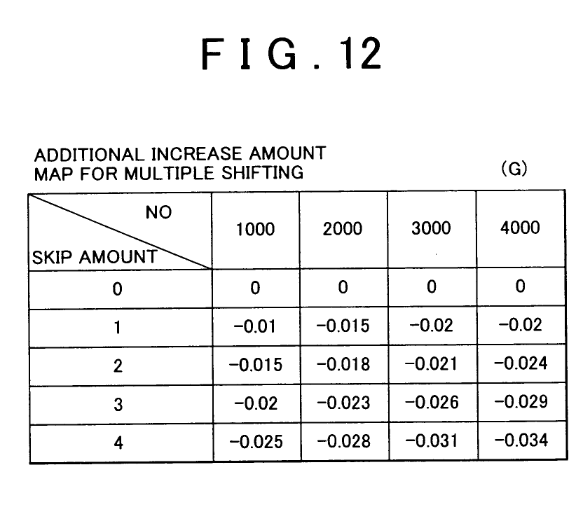

As shown in FIG. 11, when a shift command to perform shifting from sixth speed to fifth speed is output at time t1 as a shift command 501, a maximum target deceleration Gt1 corresponding to this shifting is set (in this example, there is no time lag between when the shift command is output and when the maximum target deceleration is set). The maximum target deceleration Gt1 is obtained as the sum of a maximum deceleration 402max1 for fifth speed and the braking force additional amount Gadd1 for fifth speed. In this case, when the shift command to perform shifting to fourth speed is output at time t2 which is prior to time t3 at which shifting from sixth speed to fifth speed is completed (the maximum target deceleration Gt1 is realized), it is determined that jump shifting from sixth speed to fourth speed has been performed. In this case, a maximum target deceleration Gt2 corresponding to this jump shifting is set at time t2. The maximum target deceleration Gt2 is obtained as the sum of a maximum deceleration 402max2 for fourth speed and the additional increase amount Gadd′ for the skip amount of 1.

B. Concerning Inclination α1

In step 5, the control circuit 130 decides the inclination α1 of a target deceleration 403 in addition to the above-mentioned maximum target deceleration Gt (refer to FIG. 5). The inclination α1 is decided as follows. The inclination minimum value for the target deceleration 403 for the initial stage is set based on the period ta between when the downshift command is output (as mentioned above, the downshift command is output at time t1 in step S4) and when shifting is actually (substantially) started at time t3, such that the deceleration 404 which is actually applied to the vehicle (hereinafter, referred to as “actual deceleration of the vehicle) reaches the maximum target deceleration Gt by time t3 at which shifting is started. In this case, the period ta from time t1, at which the downshift command is output, to time t3, at which shifting is actually started, is decided based on the type of shifting.

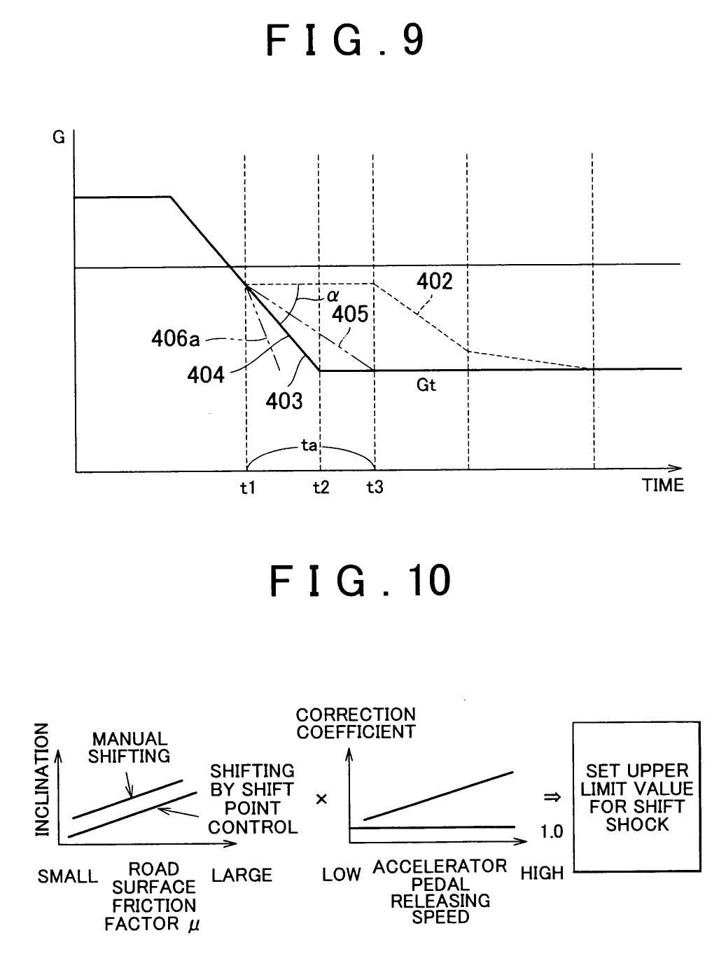

In FIG. 9, a two-dot chain line shown by a reference numeral “405” corresponds to the inclination minimum value for the target deceleration for the initial stage. Also, the upper limit value and the lower limit value are set for the inclination which can be set as the target deceleration 403 such that a shock due to deceleration does not increase and an unstable phenomenon which occurs in the vehicle can be dealt with (an unstable phenomenon can be avoided). A two-dot chain line shown by a reference numeral “406a” in FIG. 9 corresponds to the above-mentioned inclination upper limit value.

The unstable phenomenon of the vehicle means that the state of the vehicle becomes unstable. Namely, for example, grip of a tire decreases, slippage occurs, and the behavior becomes unstable for some reason such as a change in the friction factor μ of a road surface and a steering operation, when a deceleration (due to the brake control and/or engine brake due to shifting) is applied to the vehicle.

In step S5, as shown in FIG. 9, the inclination α1 of the target deceleration 403 is set to be equal to or higher than the inclination minimum value 405 and lower than the inclination upper limit value 406a (in the example shown in FIG. 5, the inclination α1 of the target deceleration 403 is a value substantially equal to the inclination minimum value 405).

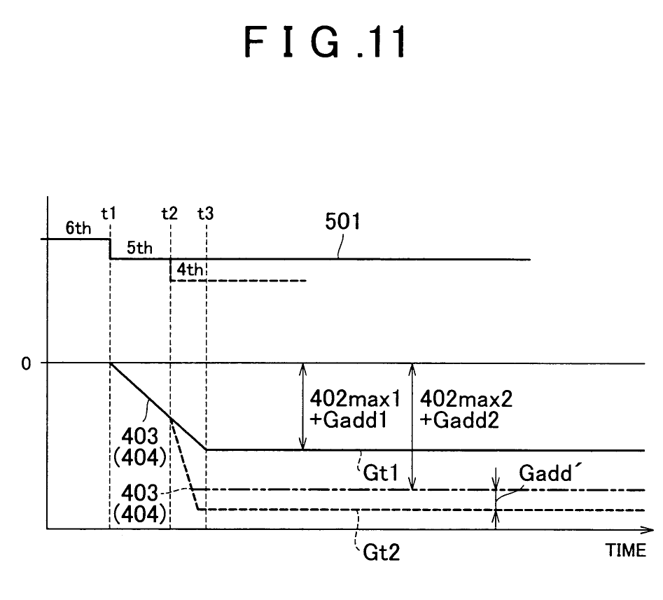

The inclination α of the target deceleration 403 for the initial stage has an effect of setting the optimum form of a change in the optimum deceleration in order to smooth the change in the deceleration of the vehicle for the initial stage and avoid an unstable phenomenon of the vehicle. The inclination α can be decided based on the accelerator pedal releasing speed (refer to ΔA0 in FIG. 5), the friction factor μ of a road surface which is detected or estimated by the road surface friction factor μ detecting/estimating portion 115, and the like. Also, the inclination α can be changed between the case where manual shifting is performed and the case where shifting by the shift point control is performed. This will be described in detail with reference to FIG. 10.

FIG. 10 shows an example of a method for setting the inclination α1. As shown in FIG. 10, the inclination α1 is set to decrease as the friction factor μ of the road surface decreases, and the inclination α1 is set to increase as the accelerator pedal releasing speed becomes higher. The inclination α when shifting by the shift point control is performed is set to be lower than the inclination α1 when manual shifting is performed. Since shifting by the shift point control does not directly depend on an intention of the driver, the rate of deceleration is set to be low (the deceleration is set to be relatively low). In FIG. 10, the relationship between the inclination α1 and road surface friction factor μ or the accelerator pedal releasing speed is liner. However, the relationship may be set to be non-liner.

In step S5, a part of the target deceleration 403 in the embodiment (a part corresponding to the period from time t2 to time t3 in FIG. 5) is decided. Namely, in step S5, the target deceleration 403 is set to reach the maximum target deceleration Gt at the inclination α1, as shown in FIG. 5. The deceleration to the maximum target deceleration Gt is realized in a shot time by a brake having good response while the deceleration shock is suppressed. By realizing the deceleration for the initial stage using the brake having good response, even of an unstable phenomenon occurs in the vehicle, appropriate measures can be taken promptly. A method of setting the target deceleration 403 after time t3 at which the target deceleration 403 reaches the maximum target deceleration Gt will be described later. After step S5 is performed, step S6 is performed.

[Step S6]

In step S6, feedback control of the brake is performed by the brake control circuit 230. As shown by the reference numeral “406”, the feedback control of the brake is started at time t2 at which the target deceleration 403 is set.

Namely, from time t2, a signal indicating the target deceleration 403 is output from the control circuit 130 to the brake control circuit 230 through the braking force signal line L1 as the braking force signal SG1. The brake control circuit 230 generates the brake control signal SG2 based on the braking force signal SG1 received from the control circuit 130, and outputs the brake control signal SG2 to the hydraulic control circuit 220.

The hydraulic control circuit 220 controls the hydraulic pressure supplied to the control devices 208, 209, 210 and 211 based on the brake control signal SG2, whereby a braking force (brake control amount 406) according to the command contained in the brake control signal SG2 is generated.

In the feedback control of the brake device 200 in step S6, the target value is the target deceleration 403, the control amount is the actual deceleration 404 of the vehicle, the control target is the brake (braking devices 208, 209, 210 and 211), the operation amount is the brake control amount 406, and external disturbance is mainly the deceleration 402 due to shifting of the automatic transmission 10. The actual deceleration 404 of the vehicle is detected by the acceleration sensor 90.

Namely, in the brake device 200, the braking force (brake control amount 406) is controlled such that the actual deceleration 404 of the vehicle becomes the target deceleration 403. The brake control amount 406 is set so as to cause a deceleration equivalent to shortage of the deceleration 402 due to shifting of the automatic transmission 10, when the target deceleration 403 is applied to the vehicle. In this case, for the sake of convenience in description, the response of the brake is high, and the actual deceleration 404 is substantially equal to the target deceleration 403.

In the example shown in FIG. 5, during the period from time t2, at which the target deceleration 403 is set, to time t3, at which shifting of the automatic transmission 10 is actually started, the deceleration 402 obtained by the automatic transmission 10 is zero. Therefore, the brake control amount 406 such that the entire target deceleration 403 can be obtained by the brake. The clutch torque 408 of the engagement side element starts to increase from time t3, and the brake control amount 406 decreases as the deceleration 402 obtained by the automatic transmission 10 increases. Since the braking force rises from time t2 before the deceleration 402 starts to be generated by the automatic transmission 10 at time t3, the actual deceleration 404 rises at time t2.

At a time at which shifting of the automatic transmission 10 is completed, namely, at time t6 at which the maximum deceleration 402max is generated, the target deceleration 403 is the maximum target deceleration Gt (refer to after-mentioned step S8). Therefore, the brake control amount 406 is a value corresponding to the additional amount Gadd (maximum target deceleration Gt−maximum deceleration 402max). After step S6 is performed, step S7 is performed.

[Step S7]

In step S7, the control circuit 130 determines whether the actual deceleration 404 is smaller than the maximum target deceleration Gt, that is, whether the actual deceleration 404 has unreached the maximum target deceleration Gt. When it is determined in step S7 that the actual deceleration 404 is smaller than the maximum target deceleration Gt, the flag F is set to “1” in step S15, afterwhich the control routine is reset.

At the beginning of the control, the actual deceleration 404 has not reached the maximum target deceleration Gt (“YES” in step S7). Therefore, the step S15, step S1 and step S2 are performed until the actual speed 404 reaches the maximum target deceleration Gt. If the accelerator pedal operation amount becomes a value other than zero (“NO” in step S1) before the actual deceleration 404 reaches the maximum target deceleration Gt, the brake control in this control (step S6) ends in step S13.

When it is determined in step S7 that the actual deceleration 404 is not smaller than the maximum target deceleration Gt (“NO” in step S7), namely, when the actual deceleration 404 has reached the maximum target deceleration Gt, step S8 is then performed. In FIG. 5, the actual deceleration 404 reaches the maximum target deceleration Gt at time t3.

[Step S8]

In step S8, the target deceleration 403 is set to the maximum target deceleration Gt. As shown in FIG. 5, after the actual deceleration 404 reaches the maximum target deceleration Gt at time t3 (“NO” in step S7), the target deceleration 403 is maintained at the maximum target deceleration Gt. Then, as described later in step S11, the actual deceleration 404 is maintained at the maximum target deceleration Gt until a predetermined period T1 has elapsed (time t7) since shifting of the automatic transmission 10 is completed at time t6. After step S8 is completed, step S9 is performed.

[Step S9]

In step S9, the control circuit 130 determines whether shifting of the automatic transmission 10 is uncompleted. The determination is made based on the rotational speed of a rotational member of the automatic transmission 10 (refer to the input rotational speed 400 in FIG. 5). In this case, the determination is made based on whether the following equation is satisfied.
No×If−Nin≦ΔNin

In this case, No signifies the rotational speed of the output shaft 120c of the automatic transmission 10, Nin signifies the input shaft rotational speed (turbine rotational speed, or the like), If signifies the gear ratio obtained after shifting is performed, and ΔNin is a constant. The control circuit 130 receives the detection result from a detection portion (not shown) for detecting the input shaft rotational speed (the rotational speed of the turbine runner 24, or the like) Nin of the automatic transmission 10.

When the above-mentioned equation is not satisfied in step S9, it is determined that shifting of the automatic transmission 10 should not to be completed. Therefore, the flag F is set to “2” in step S16, afterwhich the control routine is reset. Then, step S1, step S2 and step S9 are performed until the above-mentioned equation is satisfied. If the accelerator pedal operation amount becomes a value other than zero during the period until the above-mentioned equation is satisfied, step S13 is performed and the brake control according to the embodiment ends.

On the other hand, when the above-mentioned equation is satisfied in step S9, step S10 is then performed. In FIG. 5, shifting is completed and the above-mentioned equation is satisfied at time t6. As shown in FIG. 5, at time t6, the deceleration 402, which is applied to the vehicle due to shifting of the automatic transmission 10, reaches the maximum value 402max, and shifting of the automatic transmission 10 is completed.

[Step S10]

In step S10, the control circuit 130 determines whether the predetermined period T1 has elapsed since time t6. First, since it is determined that the predetermined period T1 has not elapsed (“NO” in step S10), the flag F is set to “3” in step S17, afterwhich the control routine is reset. Then, step S1, step S2, and step S10 are performed until the above-mentioned equation is satisfied. If the accelerator pedal operation amount becomes a value other than zero during the period until the above-mentioned equation is satisfied, step S13 is then performed and the brake control according to the embodiment ends. When it is determined in step S10 that the predetermined period T1 has elapsed, step S11 is then performed. In FIG. 5, at time t7, the predetermined period T1 has elapsed since shifting of the automatic transmission 10 is completed at time t6.

Even after shifting of the automatic transmission 10 is completed, the feedback control of the brake is continued during the predetermined period T1 such that the actual deceleration 404 becomes the maximum target deceleration Gt which is the target deceleration 403. In the embodiment, it is the object to make the driver feel that sufficient deceleration is obtained when shifting is performed. Therefore, even after shifting is completed, the maximum target deceleration Gt which is larger than the maximum deceleration 402max is continuously applied to the vehicle during the period T1, whereby the driver can feel that sufficient deceleration is obtained.

Also, the predetermined period T1 is set to a sufficiently long period in order to minimize a shock due to shifting (inertia). Therefore, a change in the torque, which is caused by disappearance of the inertia torque after shifting is completed, is prevented, and therefore the operation feeling is improved. As the shift shock control, perfect characteristics can be nominally obtained.

Generally, the driver requires deceleration, when (1) a large deceleration is required in the long term since the vehicle is running on a mountain road or a long downhill road, and (2) a certain amount of deceleration is required in the short term, for example, when manual shifting is performed in order to secure the vehicle-to-vehicle distance. The deceleration control system according to the embodiment is effective since the driver can obtain sufficient response from the vehicle and feel than a sufficient engine braking force is obtained, especially in the above-mentioned case (2).

[Step S11]

In step S11, the control circuit 130 ends the feedback control of the brake, and outputs a command for gradually decreasing the brake control amount 406. In step S11, first, the feedback control of the brake, which is started in step S6, ends. Namely, the feedback control of the brake is performed until time t7 at which the predetermined period T1 has elapsed since shifting of the automatic transmission 10 is completed. Also, in step S11, the brake control amount 406 is gradually decreased from time t7.

In FIG. 5, step S11 is performed between time t7 and time t8. The brake control amount 406 is set to be gradually decreased by the control circuit 130 such that the actual deceleration 404 is decreased at a moderate inclination α2 after time t7. The moderate inclination of the actual deceleration 404 extends to a final deceleration Ge which can be obtained by performing downshifting of the automatic transmission 10. Setting of the brake control amount 406 ends when the actual deceleration 404 reaches the final deceleration Ge. At this time, since the final deceleration G3 due to engine braking desired by downshifting is applied to the vehicle, the brake control according to the embodiment is not necessary from the time at which the actual deceleration 404 reaches the final deceleration Ge. After step S11 is performed, step S12 is performed.

[Step S12]

After the control circuit 130 resets the flag F to “0” in step S12, the control routine is reset.

According to the embodiment, the ideal deceleration transient characteristics shown by the target deceleration 403 in FIG. 5 can be obtained. When predetermined shifting is performed, control is performed such that a deceleration (maximum target deceleration Gt), which is larger than the maximum deceleration (402max) obtained by changing the shift speed, is generated. Therefore, the driver can feel that sufficient deceleration is obtained when shifting is performed. Especially, even when shifting is performed on the high shift speed side where the change amount of the engine braking force is relatively small, the driver can obtain sufficient response from the vehicle. Also, even when jump shifting is performed, the driver can feel that sufficient deceleration corresponding to the jump shifting is obtained. Recently, the number of shift speeds of the automatic transmission has been increased. Therefore, it is especially effective to use the deceleration control system according the embodiment is especially.

(1) The deceleration control system according to the embodiment is a cooperative control system of the automatic transmission and the brake when manual downshifting or the shift point control is performed. According to the embodiment, the braking force is controlled such that the target shift speed is achieved, and the target deceleration larger than the deceleration obtained by downshifting of the automatic transmission is set.

(2) The deceleration control system according to the embodiment is a cooperative control system of the automatic transmission and the brake when manual downshifting or the shift point control is performed. The braking force is added such that the deceleration larger than the deceleration obtained by downshifting of the automatic transmission is achieved.

(3) According to the embodiment, in the deceleration control system for a vehicle in the above description (1), the difference between the deceleration obtained by downshifting of the automatic transmission and the maximum target deceleration is changed based on at least the type of downshifting, the vehicle speed, and whether jump shifting has been performed.

(4) According to the embodiment, in the deceleration control system for a vehicle in the above description (2), the additional amount of deceleration obtained by the brake is changed based on at least the type of downshift, the vehicle speed, and whether jump shifting has been performed.

(5) In the embodiment, a timer is set such that deceleration obtained by the brake is made effective even after shifting of the automatic transmission is completed. In the above description (5), the maximum target deceleration obtained by the deceleration control system for a vehicle may be substantially equal to the maximum deceleration obtained by the automatic transmission. In this case as well, even after shifting of the automatic transmission is completed, deceleration performed by the brake is actively maintained. Therefore, the driver can feel that sufficient deceleration is obtained.

In the above-mentioned embodiment, deceleration is smoothly transmitted from the drive wheels to the driven wheels. Even after this, the deceleration smoothly changes to the final deceleration Ge obtained by downshifting of the automatic transmission 10. The above-mentioned ideal deceleration transient characteristics will be further described as below.

Namely, when it is confirmed (determined) in step S3 (time t1) that downshifting is required, the brake control (step S6) is performed before deceleration due to the downshifting generated (time t3). Then, the actual deceleration of the vehicle immediately starts to gradually increase at the inclination α1 without generating a large deceleration shock. Also, the actual deceleration of the vehicle increases in the range in which, even when an unstable phenomenon occurs in the vehicle, a measure can be taken. The actual deceleration increases to the maximum target deceleration Gt before time t3 at which deceleration due to shifting is generated. Also, the actual deceleration of the vehicle is gradually decreased to the final deceleration Ge without generating a large shift shock in the final stge of the shifting (after time t6).

As described above, in the embodiment, the actual deceleration of the vehicle starts to increase immediately, that is, starts to increase before the time at which deceleration due to downshifting is generated. Then, the actual deceleration is gradually increased to the maximum target deceleration Gt before time t3 at which shifting is started. Then, until time t7 at which the predetermined period T1 has elapsed since shifting is completed, the actual deceleration of the vehicle is maintained at the maximum target deceleration Gt.

According to time transition of the actual deceleration of the vehicle, if an unstable phenomenon occurs in the vehicle, it is highly possible that the unstable phenomenon occurs while the actual deceleration of the vehicle is increasing to the maximum target deceleration Gt (from time t2 to time t3), or before shifting is started (time t3), which is performed immediately after the actual deceleration of the vehicle reaches the maximum target deceleration Gt, at the latest. Only the brake operates during the period in which it is highly possible than an unstable phenomenon occurs in the vehicle (the automatic transmission 10 which has not started actual shifting is not operating). The response of the brake is good, as compared to the automatic transmission. Therefore, by controlling the brake, even when an unstable phenomenon occurs in the vehicle, a measure can be taken promptly and easily.

Namely, in order to deal with the occurrence of an unstable phenomenon in the vehicle, the operation for decreasing the braking force (the brake control amount 406) to zero or to a lower value can be performed promptly and easily with good controllability. In contrast to this, when an unstable phenomenon occurs in the vehicle after shifting of the automatic transmission has started, even if the shifting is cancelled at the time of occurrence of the unstable phenomenon, it takes long until the shifting is actually cancelled.

Also, in the above-mentioned period (from time t2 to time t3) in which it is highly possible that an unstable phenomenon occurs in the vehicle, shifting of the automatic transmission is not started and the friction engaging devices such as the clutch and the brake of the automatic transmission 10 are not engaged/applied. Therefore, if shifting of the automatic transmission 10 is cancelled in order to deal with occurrence of an unstable phenomenon in the vehicle, no problem arises.

### Second Embodiment

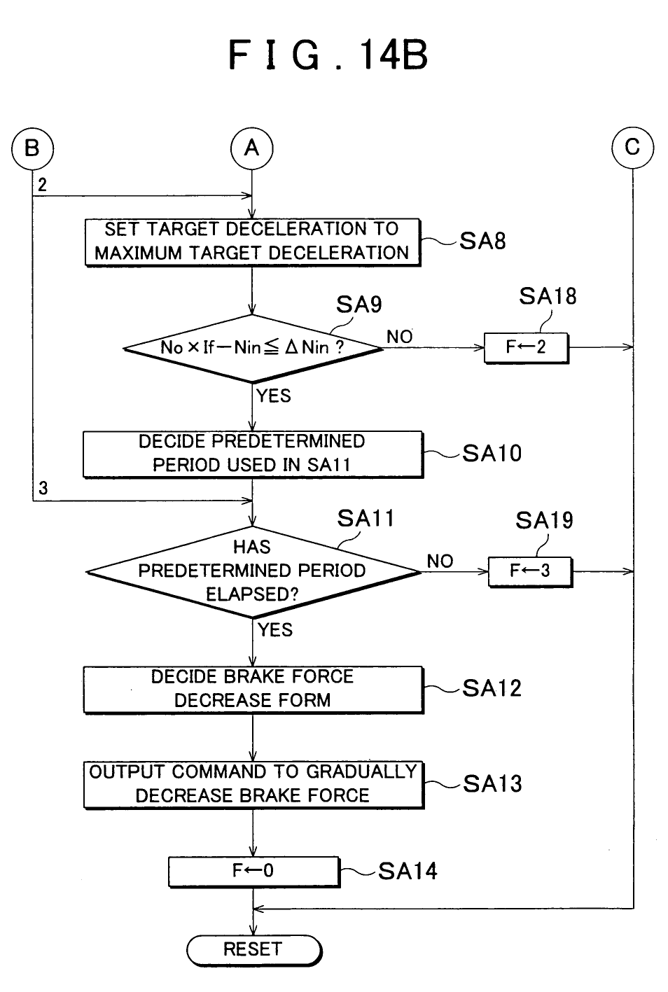

Next, a second embodiment will be described with reference to FIGS. 14A to 20. In the second embodiment, the same elements as those in the first embodiment will not be described, and only the elements which are not in the first embodiment will be described here.

In the second embodiment, the maximum target deceleration Gt, the decrease inclination α2 of the brake control amount 406, and the predetermined period T1 in the first embodiment are changed based on a running environment. The steps will be described below.

[Step SA5]

In step SA5 in FIG. 14A, as in the first embodiment, first, (1) the maximum deceleration 402max of the deceleration 402 due to shifting is obtained with reference to FIG. 6, (2) the additional amount Gadd of the deceleration is obtained with reference to FIG. 7, and (3) the additional increase amount Gadd′ when jump shifting is performed is obtained with reference to FIG. 12 or FIG. 13. Next, the additional amount Gadd of the deceleration is added to the additional increase amount Gadd′ for multiple shifying, whereby a total additional amount Gadds is obtained.

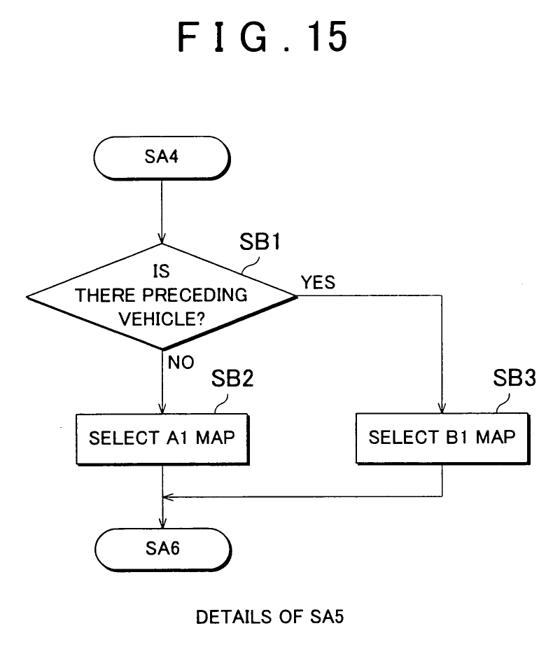

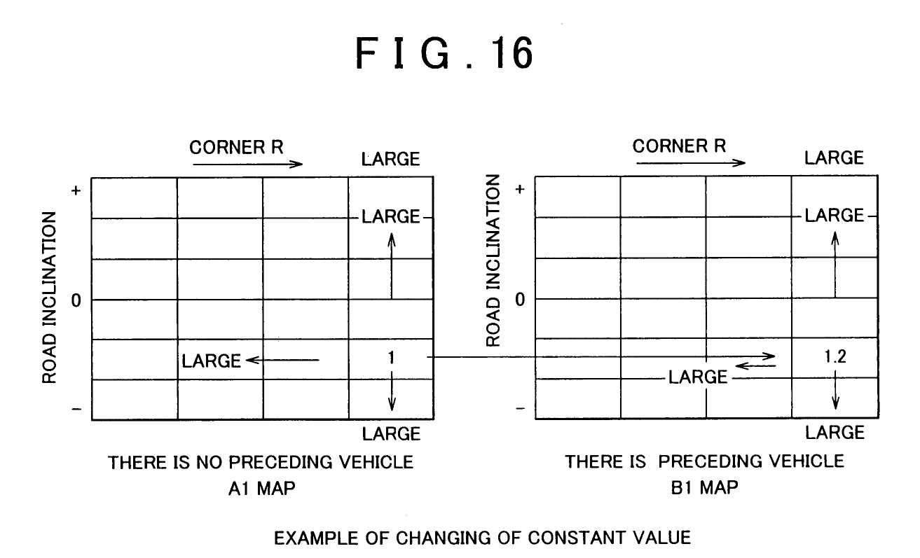

In step SA5, as shown in FIG. 15, it is determined in step SB1 whether there is a preceding vehicle ahead of the host vehicle. If it is determined that there is no preceding vehicle, an Map A1 in FIG. 16 is selected in step SB2. If it is determined that there is a preceding vehicle, a Map B1 in FIG. 16 is selected in step SB3.

The control circuit 130 determines in step SB1 whether a distance between the host vehicle and the preceding vehicle is equal to or shorter than a predetermined value based on a signal indicating the vehicle-to-vehicle distance received from the vehicle-to-vehicle distance measuring portion 100. When the vehicle-to-vehicle distance is equal to or shorter than the predetermined value, it is determined that there is a preceding vehicle. Instead of directly determining whether the vehicle-to-vehicle distance is equal to or shorter than the predetermined value, the control circuit 130 may indirectly determine whether the vehicle-to-vehicle distance is equal to or shorter than the predetermined value using parameters such as collision time (vehicle-to-vehicle distance/relative vehicle speed), inter-vehicle time (vehicle-to-vehicle distance/vehicle speed of the host vehicle), the combination thereof, or the like. Whether the vehicle-to-vehicle distance is equal to or shorter than the predetermined value can be determined by using these parameters. The operation in step SB1 is the same as after-mentioned step SC1 and step SD1.

The control circuit 130 obtains a radius or a curvature R of a corner ahead of the host vehicle based on the map information received from the navigation system device 113, and obtains the road inclination using the road inclination measuring/estimating portion 118. When there is no preceding vehicle (step SB2), a constant K is obtained based on the obtained corner R ahead of the host vehicle and the road inclination with reference to the Map A1. On the other hand, when there is a preceding vehicle (step SB3), the constant K is obtained based on the obtained corner R ahead of the host vehicle and the road inclination with reference to the map B1.

If the corner R and the road inclination are the same in the Map A1 and the Map B1, the constant K in the Map B1 is set to be larger than the constant K in the Map A1 (the reference value is set to “1” in the Map A1, and “1.2” in the Map B1).

In both the Map A1 and the Map B1, the constant K becomes the reference value (“1” in the Map A1, and “1.2” in the Map B1) when the corner R is the maximum value and the road inclination is a predetermined negative value. Also, in both the Map A1 and the Map B1, as the corner R becomes smaller than the value of the corner R corresponding to the reference value by a lager amount, the constant K becomes larger than the reference value by a larger amount. Also, in both the Map A1 and the Map B1, regardless of whether the road inclination is larger or smaller than the value of the road inclination corresponding to the reference value, the constant K becomes larger than the reference value.

As described above, when the constant K is obtained with reference to the Map A1 or the Map B1 in FIG. 16 according to the routine in FIG. 15, a correction amount of the additional amount (hereinafter, referred to as an “additional correction amount”) Gadda, which is the product of the constant K and the total additional amount Gadds, is obtained. The sum of the maximum deceleration 402max of the deceleration 402 and the additional correction amount Gadda is obtained as the maximum target deceleration Gt.

In the second embodiment, when the maximum target deceleration Gt is decided, the additional amount of the braking force which is added to the maximum deceleration 402max is changed based on the running environment (whether there is a preceding vehicle, the road inclination and the corner R ahead of the host vehicle). As a result, the driver can feel that further appropriate deceleration based on the running environment is obtained.

[Step SA10]

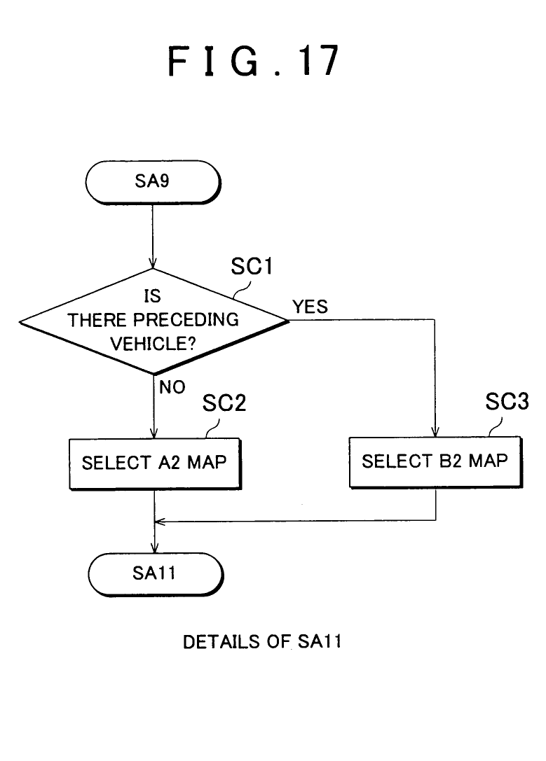

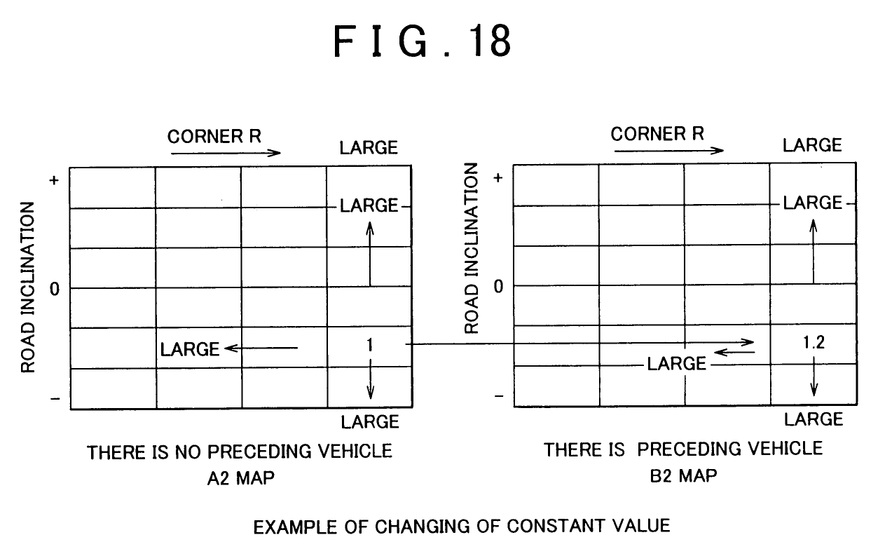

In step SA10, the predetermined period T1 used in step SA11 is decided. In step S10 in the first embodiment, the predetermined period T1, which is uniformly set independently of a change in the running environment, is used. However, in the second embodiment, the predetermined period T1 variable based on the running environment is obtained. A method for obtaining the predetermined period T1 in the second embodiment will be described with reference to FIGS. 17 and 18.

As shown in FIG. 17, it is determined in step SA10 whether there is a preceding vehicle ahead of the host vehicle in step SC1. When it is determined that there is no preceding vehicle, a Map A2 in FIG. 18 is selected in step SC2. On the other hand, when it is determined that there is a preceding vehicle, a Map B2 in FIG. 18 is selected in step SC3.

When there is no preceding vehicle (step SC2), a constant Kt is obtained based on the obtained corner R ahead of the vehicle and road inclination with reference to the Map A2. On the other hand, when there is a preceding vehicle (step SC3), the constant Kt is obtained based on the obtained corner R ahead of the host vehicle and road inclination obtained with reference to the Map B2.

If the corner R and the road inclination are the same, the constant Kt in the Map B2 is set to be larger than the constant Kt in the Map A2 (the reference value is set to “1” in the Map A2, and “1.2” in the Map B2).

In both the Map A2 and the Map B2, the constant Kt becomes the reference value (“1” in the Map A2, and “1.2” in the Map B2) when the corner R is the maximum and the road inclination is a predetermined negative value. In both the Map A2 and the Map B2, as the corner R becomes smaller than the value of the corner R corresponding to the reference value by a larger amount, the constant Kt becomes larger than the reference value by a larger amount. In both the Map A2 and the Map B2, the constant Kt becomes larger than the reference value regardless of whether the road inclination is larger or smaller than the value of the road inclination corresponding to the reference value.

As described above, when the constant Kt is obtained with reference to the Map A2 or the Map B2 in FIG. 18 according to the routine in FIG. 17, the predetermined period T1 is obtained as a product of the constant Kt and a reference period Ts stored in the ROM 133 as a reference value in advance.

In the second embodiment, since the predetermined period T1 is changed based on the running environment, the driver can feel that further appropriate deceleration based on the running environment is obtained.

[Step SA12]

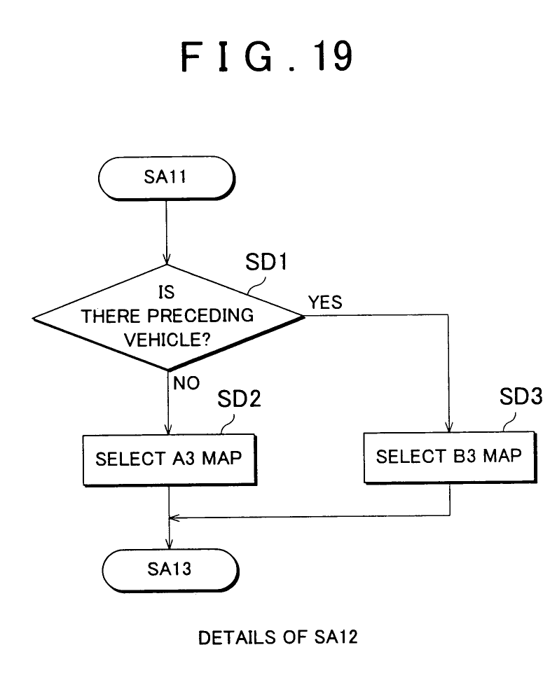

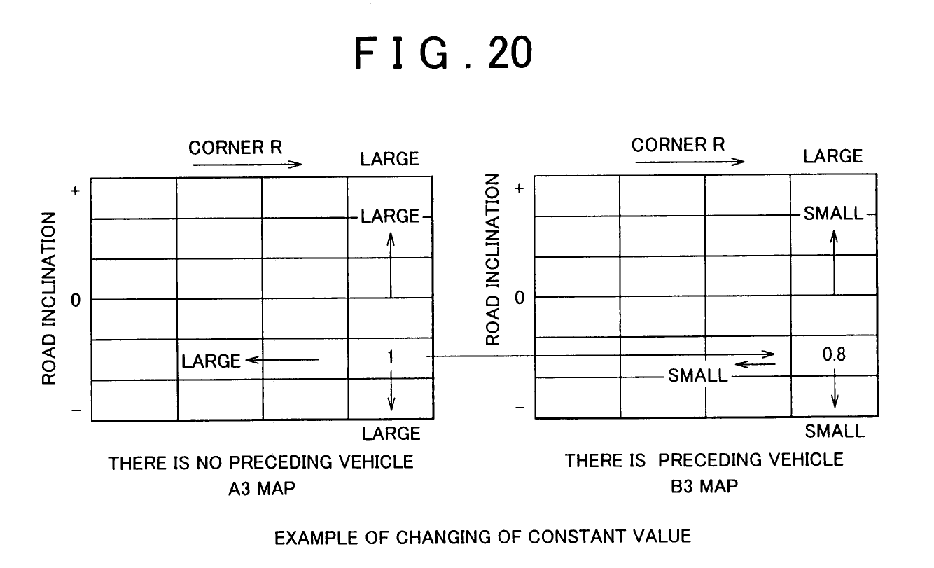

In step SA12 in FIG. 14B, the control circuit 130 decides the deceleration mode of the braking force used in step SA13. In step S11 in the first embodiment, the decrease inclination α2 of the deceleration, which uniformly is set independently of the change in the environment, is used. However, in the second embodiment, a decrease inclination α2 variable based on the running environment is obtained. A method for obtaining the decrease inclination α2 in the second embodiment will be described with reference to FIGS. 19 and 20.

As shown in FIG. 19, in step SA12 it is determined in step SD1 whether there is a preceding vehicle ahead of the host vehicle. When it is determined that there is no preceding vehicle, a Map A3 in FIG. 20 is selected in step SD2. On the other hand, when it is determined that there is a preceding vehicle, a Map B3 in FIG. 20 is selected in step SD3.

When there is no preceding vehicle (step SD2), a constant Kα is obtained based on the obtained corner R ahead of the vehicle and road inclination with reference to the Map A3. On the other hand, when there is a preceding vehicle (step SD3), the constant Kα is obtained based on the obtained corner R ahead of the vehicle and road inclination with reference to the Map B3.

If the corner R and the road inclination are the same, the constant Kα in the B3 map is set to be smaller than the constant Kα in the Map A3 (the reference value is set to “1” in the Map A3, and “0.8” in the Map B3).

In both the Map A3 and the Map B3, the constant Kα becomes the reference value (“1” in the Map A3, and “0.8” in the Map B3) when the corner R is the maximum value and the road inclination is a predetermined negative value. In both the Map A3 and the Map B3, as the corner R becomes smaller than the value of the corner R corresponding to the reference value by a larger amount, the constant Kα becomes smaller than the reference value by a larger amount. In both the Map A3 and the Map B3, the constant Kα becomes smaller than the reference value regardless of whether the road inclination is larger or smaller than the value of the road inclination corresponding to the reference value.

As described above, when the constant Kα is obtained with reference to the Map A3 or the Map B3 in FIG. 20, according to the routine in FIG. 19, the decrease inclination α2 is obtained as a product of the constant Kα and a reference period as stored in the ROM 133 in advance as a reference value.

In the second embodiment, since the decrease inclination α2 is changed based on the running environment, the driver can feel that further appropriate deceleration based on the running environment is obtained.

As described above, in the second embodiment, each of the maximum target deceleration Gt, the predetermined period T1 and the decrease inclination α2 is changed based on the running environment. Therefore, the driver can feel that further appropriate deceleration based on the running environment is obtained. In the second embodiment, all the maximum target deceleration Gt, the predetermined period T1 and the decrease inclination α2 are variable based on the running environment. However, only one or two among the maximum target deceleration Gt, the predetermined period T1 and the decrease inclination α2 may be variable on the running environment.

### Modified Example of Second Embodiment

In the second embodiment, the predetermined period T1 and the decrease inclination α2 are obtained by multiplying the reference values Ts and αs stored in the ROM in advance by the constants Kt and Kα set based on the running environment, respectively. However, in a modified example, as in the first embodiment in which the additional amount of the braking force is decided based on the vehicle speed, the type of shifting and whether jump shifting has been performed, the predetermined period T1 and the decrease inclination α2 can be decided based on the vehicle speed, the type of shifting and whether jump shifting has been performed. In this case, further, as in the second embodiment, each of the predetermined period T1 and the decrease inclination α2 may be changed by the product of the reference value and the constant set based on the running environment.

The above-mentioned embodiments may be realized on various modified examples. For example, in the above-mentioned embodiments, the description is made concerning the example in which the control of the brake. However, instead of the brake, regenerative control by a MG device (in the case of a hybrid system) provided in a train system may be used. Also, in the above-mentioned embodiments, the description is made concerning the example in which the stepped automatic transmission 10 is used as a transmission. However, the invention can be applied to a CVT. As the control of the brake, the description is made concerning a method in which a target shift speed is set, and the brake is controlled in a feedback manner in order to realize the set target deceleration. Instead of this, a method in which the braking force is increased at a predetermined inclination by sequence control may be employed. In the above-mentioned embodiments, as the deceleration indicating the amount of deceleration of the vehicle, the deceleration (G) is used. However, control may be performed based on deceleration torque.

1. A deceleration control system for a vehicle, comprising:
a braking device which applies a braking force to a vehicle when a determination that a shift speed or a gear ratio of a transmission of a vehicle is changed to a shift speed or a gear ratio for a relatively low vehicle speed is made; and
a control device which controls a deceleration that is applied to the vehicle by the braking device, the deceleration being applied to a deceleration that is applied to the vehicle by performing a shift operation for changing the shift speed or the gear ratio of the transmission to the shift speed or the gear ratio for the relatively low vehicle speed.

2. The deceleration control system according to claim 1, wherein the deceleration added by the braking device is decided based on at least one of the shift speed or the gear ratio obtained after shifting performed by the shift operation, a type of shifting performed by the shift operation, whether jump shifting has been performed by the shift operation, and a speed of the vehicle.

3. The deceleration control system according to claim 1, wherein the control device performs control such that the deceleration that is applied to the vehicle by activating the braking device and performing the shift operation for changing the shift speed or the gear ratio of the transmission to the shift speed or the gear ratio for the relatively low vehicle speed becomes larger than the deceleration that is applied to the vehicle by only performing the shift operation for changing the shift speed or the gear ratio of the transmission to the shift speed or the gear ratio for the relatively low vehicle speed.

4. The deceleration control system according to claim 3, wherein the deceleration that is applied to the vehicle by activating the braking device and performing the shift operation is decided based on at least one of the shift speed or the gear ratio obtained after shifting performed by the shift operation, a type of shifting performed by the shift operation, whether jump shifting has been performed by the shift operation, and a speed of the vehicle.

5. The deceleration control system according to claim 1, wherein an application of the braking force, which is generated by the braking device, to the vehicle is controlled to be maintained even after the shift operation ends.

6. The deceleration control system according to claim 5, wherein the application of the braking force, which is generated by the braking device, to the vehicle is controlled to be maintained for a predetermined period after the shift operation ends, and the predetermined period is decided based on a running environment of the vehicle.

7. The deceleration control system according to claim 1, wherein the deceleration applied to the vehicle is decided based on a running environment of the vehicle.

8. A deceleration control method for a vehicle, comprising the steps of:
applying a braking force to a vehicle when a determination that a shift speed or a gear ratio of a transmission of a vehicle is changed to a shift speed or a gear ratio for a relatively low vehicle speed is made; and
controlling a deceleration that is applied to the vehicle by a braking device, the deceleration being added to a deceleration that is applied to the vehicle by performing a shift operation for changing the shift speed or the gear ratio of the transmission to the shift speed or the gear ratio for the relatively low vehicle speed.

9. The deceleration control method according to claim 8, wherein the deceleration added by the braking device is decided based on at least one of the shift speed or the gear ratio obtained after shifting performed by the shift operation, a type of shifting performed by the shift operation, whether jump shifting has been performed by the shift operation, and a speed of the vehicle.

10. The deceleration control method according to claim 8, wherein the deceleration that is applied to the vehicle by activating the braking device and performing the shift operation for changing the shift speed or the gear ratio of the transmission to the shift speed or the gear ratio for the relatively low vehicle speed is controlled such that the deceleration becomes larger than the deceleration that is applied to the vehicle by only performing the shift operation for changing the shift speed or the gear ratio of the transmission to the shift speed or the gear ratio for the relatively low vehicle speed.

11. The deceleration control method according to claim 10, wherein the deceleration that is applied to the vehicle by activating the braking device and performing the shift operation is decided based on at least one of the shift speed or the gear ratio obtained after shifting performed by the shift operation, a type of shifting performed by the shift operation, whether jump shifting has been performed by the shift operation, and a speed of the vehicle.

12. The deceleration control method according to claim 8, wherein an application of the braking force, which is generated by the braking device, to the vehicle is controlled to be maintained even after the shift operation ends.

13. The deceleration control method according to claim 12, wherein the application of the braking force, which is generated by the braking device, to the vehicle is controlled to be maintained for a predetermined period after the shift operation ends, and the predetermined period is decided based on a running environment of the vehicle.

14. The deceleration control method according to claim 8, wherein the deceleration applied to the vehicle is decided based on a running environment of the vehicle.
